(19) United States
(12) Patent Application Publication
(10) Pub. No.: US 2020/0056004 A1
(43) Pub. Date: Feb. 20, 2020

(54) Polyethylene Films

(71) Applicant: ExxonMobil Chemical Patents Inc., Baytown, TX (US)

(72) Inventors: Zhen-Yu Zhu, Shanghai (CN); Wei Qin, Shanghai (CN); Zhi-Yi Shen, Shanghai (CN)

(21) Appl. No.: 16/461,343

(22) PCT Filed: Nov. 8, 2017
(86) PCT No.: PCT/US2017/060632

§ 371 Date: May 15, 2019

Related U.S. Application Data
(60) Provisional application No. 62/429,420, filed on Dec. 2, 2016.

(30) Foreign Application Priority Data
Jan. 31, 2017 (EP) 17153956.2

(51) Int. Cl. C08J 5/18; C08L 23/06

(52) U.S. Cl. CPC C08J 5/18; C08L 23/06; C08J 2323/06; C08L 23/0815; C08L 2207/06; C08L 2205/025; C08L 2203/16

(57) ABSTRACT

Films made from at least two polyethylene polymers differentiated in density, melt index, melt index ratio, or branching index and optionally, with other polymers, are disclosed.

### CROSS REFERENCE TO RELATED APPLICATIONS

The present application claims priority to U.S. Provisional Application No. 62/429,420 filed Dec. 2, 2016 and EP Application No. 17153956.2 filed Jan. 31, 2017, the disclosures of which are hereby incorporated by reference in their entireties.

### FIELD OF THE INVENTION

The present invention generally relates to polyethylene films made from metallocene-catalyzed polyethylene polymers, optionally, including other polymers.

### BACKGROUND OF THE INVENTION

Metallocene polyethylene (mPE) resins such as those available from ExxonMobil Chemical Company, Houston, Tex., have revolutionized the plastics industry by improving upon polymer properties that have enhanced several end use applications and created several new ones. In general, mPE provides for a good balance of operational stability, extended output, versatility with higher alpha olefin (HAO) performance, toughness and strength, good optical properties, down gauging opportunities, and resin sourcing simplicity. See, jbr example, U.S. Patent Application Publication Nos. 2009/0297810, 2015/0291748, U.S. Pat. No. 6,956,088, and WO 2014/099356. However, for certain applications, more improvements are still required.

For many applications, including films and fibers, higher stiffness, which can be indicated by 1% secant modulus, is desired to allow use of thinner films in production for reasons such as cost savings. Applications include but are not limited to mulch films, silage stretch film, lamination films, films for bag-in-box etc. It is generally thought that film stiffness increases with the film density.

Additionally, good film toughness, such as tear strength and puncture resistance are desirable attributes. A higher tear strength allows fabricators to run their blown film lines at a faster rate and provides better stretchability of the films. It also allows them to handle thicker films in applications such as geomembranes. However, it has been known in the art that for many polyethylene polymers or their blend compositions, the tear strength of a film decreases along with an increase in the average density. A further challenge in some applications is providing a thicker film with good optical performance, e.g., gloss performance, since gloss is known to decrease as film thickness increases.

Accordingly there is a need to provide a film that has both desired stiffness, e.g., 1% secant modulus, and toughness, e.g., tear strength and puncture resistance, and preferably such film has a small thickness. It is also desired to have good optical performance in such high density and/or high thickness film.

### SUMMARY OF THE INVENTION

In a class of embodiments, the invention provides for a film made from a polyethylene composition comprising from about 5 wt % to about 95 wt % a first polyethylene polymer and from about 95 wt % to about 5 wt % of a second polyethylene polymer, the first polyethylene polymer comprising from about 70 wt % to about 100 wt % ethylene derived units and having a density of from about 0.910 g/cm³ and less than about 0.940 g/cm³ and a branching index g'vis of about 0.98 or more, a melt index ratio (I_{21.6}/I_{2.16}) of from about 20 to about 35; and the second polyethylene polymer comprising from about 80 wt % to about 99 wt % of ethylene derived units and having a density of from about 0.905 g/cm³ to about 0.945 g/cm³, a branching index g'vis of less than about 0.98, and a melt index ratio (I_{21.6}/I_{2.16}) of from about 25 to about 80.

In some embodiments the polymer composition may comprise from about 25 wt % to about 95 wt %, or from about 45 wt % to about 95 wt % of the first polyethylene polymer and from about 75 wt % to about 5 wt %, or from about 55 wt % to about 5 wt % of the second polyethylene polymer.

In some embodiments the first polyethylene polymer has a branching index of greater than about 0.99, and/or a density of from about 0.912 g/cm³ to about 0.925 g/cm³, and/or a melt index ratio (I_{21.6}/I_{2.16}) of from about 25 to about 32.

In certain embodiments the first polyethylene polymer can be characterized by at least one of the following:

(1) a melt index (I_{2.16}) of from about 0.1 g/10 min to about 5.0 g/10 min, or from about 0.2 g/10 min to about 1.5 g/10 min;

(2) a molecular weight of from about 15,000 to about 400,000 g/mol, or from about 20,000 to about 200,000 g/mol;

(3) a molecular weight distribution (Mw/Mn) of from about 1.5 to bout 5.0, or from about 2.0 to about 4.0;

(4) a CDBI of less than about 50%, or less than about 45%;

(5) a hafnium concentration of less than about 5 ppm by weight, or less than about 2 ppm by weight;

(6) a hafnium to zirconium ratio (ppm/ppm)≥about 1.0, or ≥about 2.0;

(7) an orthogonal comonomer distribution and/or has at least a first peak and at least a second peak in a comonomer distribution analysis;

(8) at least a first peak and a second peak in a comonomer distribution analysis and wherein the first peak has a maximum at a log (Mw) value of from about 4.0 to about 5.4, or from about 4.3 to about 5.0, and a TREF elution temperature of from about 70.0° C. to about 100.0° C., or from about 80.0° C. to about 95.0° C., and the second peak has a maximum at a log (Mw) value of from about 5.0 to about 6.0, or from about 5.0 to about 5.7, and a TREF elution temperature of from about 40.0° C. to about 70.0° C., or from about 45.0° C. to about 65.0° C.; and

(9) made with a metallocene catalyst.

In some embodiments the second polyethylene polymer has a density of from about 0.915 g/cm³ to about 0.945 g/cm³, a branching index of from about 0.65 to about 0,98, a melt index ratio (I_{21.6}/I_{2.16}) of from about 35 to about 70.

In some embodiments the second polyethylene polymer can be characterized by at least one of the following:

(1) a melt index (I_{2.16}) of from about 0.100 min to about 3.0 g/10 min, or from about 0.2 g/10 min to about 2.0 g/10 min;

(2) a CDBI of greater than about 50%, or at least about 70%;

(3) a molecular weight distribution (Mw/Mn) of from about 2.5 to about 5.5, or from about 3.0 to about 4.0; and

(4) made with a metallocene catalyst.

In some preferred embodiments the film of the present invention can be characterized in at least one of the following properties:

(1) a film density of greater than about 0.915 g/cm³, or from about 0.915 to about 0.945 g/cm³,

(2) an MD Elmendorf tear strength, as determined according to ASTM D-1922, of greater than about 6.0 g/μm;

(3) a puncture resistance, as determined according to ASTM D-5748, of greater than about 55 N, or greater than about 58 N;

(4) a 45° gloss, as determined by ASTM D-2457, of greater than about 35 GU, or greater than about 40 GU, or greater than about 50 GU;

(5) an MD 1% secant modulus, as determined according to ASTM D-882, of greater than about 150 MPa, or greater than about 190 MPa; and

(6) a thickness of less than about 100 μm, or less than about 50 μm, or a thickness of greater than about 25 μm, or greater than 50 μm, or greater than 100 μm.

The present application in a further aspect provides a laminate or an article comprising the film described herein.

In one particular embodiment, the present invention provides a film made from at least a polymer composition comprising from about 25 wt % to about 95 wt % of a first polyethylene polymer and from about 75 wt % to about 5 wt % of a second polyethylene polymer, wherein the first polyethylene polymer comprises from about 70 wt % to about 100 wt % ethylene derived units and having a density of from about 0.910 g/cm³ to about 0.940 g/cm³ and a branching index g′ᵥᵢₛ of about 0,98 or more, a melt index ratio (I_{21.6}/I_{2.16}) of from about 20 to about 35, and the second polyethylene polymer comprises from about 80 wt % to about 99 wt % of ethylene derived units and having a density of from about 0.915 g/cm³ to about 0.945 g/cm³, a branching index g′ᵥᵢₛ of less than about 0.98, and a melt index ratio (I_{21.6}/I_{2.16}) of from about 25 to about 80; wherein the film has an average density of greater than about 0.915 g/cm³, an MD Elmendorf tear strength, as determined according to ASTM D-1922, of greater than about 6.0 g/nm, an MD 1% secant modulus, as determined according to ASTM D-882, of greater than about 150 MPa, and preferably a thickness of less than 100 μm.

In one particular embodiment, the present invention provides a film made from at least a polymer composition comprising from about 25 wt % to about 95 wt % of a first polyethylene polymer and from about 75 wt % to about 5 wt % of a second polyethylene polymer, wherein the first polyethylene polymer comprises from about 70 wt % to about 100 wt % ethylene derived units and having a density of from about 0.910 g/cm³ to about 0.940 g/cm³ and a branching index g′ᵥᵢₛ of about 0.98 or more, a melt index ratio (I_{21.6}/I_{2.16} of from about 20 to about 35, and the second polyethylene polymer comprises from about 80 wt % to about 99 wt % of ethylene derived units and having a density of from about 0.915 g/cm³ to about 0.945 g/cm³, a branching index g′ᵥᵢₛ of less than about 0.98. and a melt index ratio (I_{21.6}/I_{2.16}) of from about 25 to about 80; wherein the film has an MD Elmendorf tear strength, as determined according to ASTM D-1922, of greater than about 6.0 g/nm, an MD 1% secant modulus, as determined according to ASTM D-882, of greater than about 150 MPa, and a thickness of greater than about 25 μm, and a 45° gloss, as determined according to ASTM D-2457, of greater than about 35 GU.

The present application in still another aspect provides a method of improving the 45° gloss of a film, where the film is made from a polymer composition comprising a first polyethylene polymer and a second polyethylene polymer, wherein the first polyethylene polymer comprises from about 70 wt % to about 100 wt % ethylene derived units and having a density of from about 0.910 g/cm³ to about 0.940 g/cm³ and a branching index g′ᵥᵢₛ of about 0.98 or more, a melt index ratio (I_{21.6}/I_{2.16}) of from about 20 to about 35, and the second polyethylene polymer comprises from about 80 wt % to about 99 wt % of ethylene derived units and having a density of from about 0.905 g/cm³ to about 0.945 g/cm³, a branching index g′ᵥᵢₛ of less than about 0.98, and a melt index ratio (I_{21.6}/I_{2.16}) of from about 25 to about 80; wherein the method comprises the step of increasing the thickness of the film. In some preferred embodiments, the film thickness can be increased till being greater than about 25 μm; or greater than about 50 μm; or greater than about 100 μm.

### BRIEF DESCRIPTION OF THE DRAWINGS

FIG. 1 is a 317 model simulated based on examples 1 to 17 showing the correlation between the MD Elmendorf tear of the film, the content of the first polyethylene polymer content, and density of the second polyethylene polymer.

FIG. 2 is a 3D model simulated based on examples 1 to 17 showing the correlation between the puncture resistance force, the content of the first polyethylene polymer, and the density of the second polyethylene polymer.

FIG. 3 is a 3D model simulated based on examples 1 to 17 showing the correlation between the gloss, the film thickness, and the density of second polyethylene polymer.

FIG. 4 is a 3D model simulated based on examples 1 to 17 showing the correlation between the film gloss, the film thickness, and the content of the first polyethylene polymer.

### DETAILED DESCRIPTION OF ILLUSTRATIVE EMBODIMENTS

Now the present application will be described in details. In the present application, it has been surprisingly found that when at least combining a first polyethylene polymer and a second polyethylene polymer, as described herein, to form a polymer composition suitable for making a film, when the average density of the film made increases, the film formed does not exhibit the decreasing trend on toughness properties, such as tear strength and puncture resistance force while an increased stiffness, e.g., indicated by 1% secant modulus, can be obtained, which unexpectedly brings advantageous to application that requires both high stiffness and high toughness. In the meantime, it has also been surprisingly found that when at least combining the first polyethylene polymer and the second polyethylene polymer to form a polymer composition suitable for making a film, when the thickness of the film formed increases, the gloss is significantly increased. Additionally, it has been found that combining the first polyethylene polymer and second polyethylene polymer results in improved processability over films made from conventional LLDPE.

Before the present polymers, compounds, components, compositions, and/or methods are disclosed and described, it is to be understood that unless otherwise indicated this invention is not limited to specific polymers, compounds, components, compositions, reactants, reaction conditions, ligands, metallocene structures, or the like, as such may vary, unless otherwise specified. It is also to be understood that the terminology used herein is for the purpose of describing particular embodiments only and is not intended to be limiting.

It must also be noted that, as used in the specification and the appended claims, the singular forms “a,” “an” and “the” include plural referents unless otherwise specified.

### Definitions

For the purposes of this disclosure, the following definitions will apply, unless otherwise stated:

molecular weight distribution (“MWD”) is equivalent to the expression M_{w}/Mₙ. The expression M_{w}/Mₙ is the ratio of the weight average molecular weight (M_{w}) to the number average molecular weight (Mₙ). The weight average molecular weight is given by

$${M}_{w} = \frac{{\sum }_{i} {n}_{i} {M}_{i}^{2}}{{\sum }_{i} {n}_{i} {M}_{i}} ,$$

the number average molecular weight is given by

$${M}_{n} = \frac{{\sum }_{i} {n}_{i} {M}_{i}}{{\sum }_{i} {n}_{i}} ,$$

the z-average molecular weight is given by

$${M}_{z} = \frac{{\sum }_{i} {n}_{i} {M}_{i}^{3}}{{\sum }_{i} {n}_{i} {M}_{i}^{2}} ,$$

where nᵢ in the foregoing equations is the number fraction of molecules of molecular weight Mᵢ. Measurements of M_{w}, M_{z}, and Mₙ are determined by Gel Permeation Chromatography. The measurements proceed as follows. Gel Permeation Chromatography (Agilent PL-220), equipped with three in-line detectors, a differential refractive index detector (DRI), a light scattering (LS) detector, and a viscometer, is used. Experimental details, including detector calibration, are described in: I. Sun, P. Brant, R. R. Chance, and W. W. Graessley, Macromolecules, Volume 34, Number 19, pp. 6812-6820, (2001). Polystyrene is used for calibration. Three Agilent PLgel 10 μm Mixed-B LS columns are used. The nominal flow rate is 0.5 mL/min, and the nominal injection volume is 300 μL. The various transfer lines, columns, viscometer and differential refractometer (the DRU detector) are contained in an oven maintained at 145° C. Solvent for the experiment is prepared by dissolving 6 grams of butylated hydroxytoluene as an antioxidant in 4 liters of Aldrich reagent grade 1,2,4-trichlorobenzene (TCB). The TCB mixture is then filtered through a 0.1 μm Teflon filter. The TCB is then degassed with an online degasser before entering the GPC-3D. Polymer solutions are prepared by placing dry polymer in a glass container, adding the desired amount of TCB, then heating the mixture at 160° C. with continuous shaking for about 2 hours. All quantities are measured gravimetrically. The TCB densities used to express the polymer concentration in mass/volume units are 1.463 g/ml at about 21° C. and 1.284 g/ml at 145° C. The injection concentration is from 0.5 to 2.0 mg/nil, with lower concentrations being used for higher molecular weight samples. Prior to running each sample, the DRI detector and the viscometer are purged. The flow rate in the apparatus is then increased to 0.5 mi/minute, and the DRI is allowed to stabilize for 8 hours before injecting the first sample. The LS laser is turned on at least 1 to 1.5 hours before running the samples. The concentration, c, at each point in the chromatogram is calculated from the baseline-subtracted DRI signal, I_{DRI}, using the following equation:

c−K_{DRI}I_{DRIT}/(dn/dc),

where K_{DRI} is a constant determined by calibrating the DRI, and (dn/dc) is the refractive index increment for the system. The refractive index, n=1.500 for TCB at 145° C. and λ=690 nm. Units on parameters throughout this description of the GPC-3D method are such that concentration is expressed in g/cm³, molecular weight is expressed in g/mole, and intrinsic viscosity is expressed in dL/g.

The LS detector is a Wyatt Technology High Temperature DAWN HELEOS. The molecular weight, M, at each point in the chromatogram is determined by analyzing the LS output using the Zimm model for static light scattering (M. B. Huglin, LIGHT SCATTERING FROM POLYMER SOLUTIONS, Academic Press, 1971):

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the DRI analysis, A₂ is the second virial coefficient. P(θ) is the form factor for a monodisperse random coil, and Kₒ is the optical constant for the system:

$${K}_{o} = \frac{4 {π}^{2} {{n}^{2} ( dn / d c )}^{2}}{{λ}^{4} {N}_{A}} ,$$

where N_{A} is Avogadro's number, and (dn/dc) is the refractive index increment for the system, which take the same value as the one obtained from DRI method. The refractive index, n=1.500 for TCB at 145° C. and λ=657 nm.

A high temperature Viscotek Corporation viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηₛ=c[η]+0.3(c[η])²,

where c is concentration and was determined from the DRI output.

The branching index (g′ᵥᵢₛ) is calculated using the output of the GPC-DRI-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}} ,$$

where the summations are over the chromatographic slices, i, between the integration limits.

The branching index g′ᵥᵢₛ is defined as:

$${g}^{′} vis = \frac{{[ η ]}_{avg}}{k {M}_{v}^{α}} .$$

Mᵥ, is the viscosity-average molecular weight based on molecular weights determined by LS analysis. Z average branching index (g′zₐᵥₑ) is calculated using Ci=polymer concentration in the slice i in the polymer peak times the mass of the slice squared, Mi². All molecular weights are weight average unless otherwise noted. All molecular weights are reported in g/mol unless otherwise noted. This method is the preferred method of measurement and used in the examples and throughout the disclosures unless otherwise specified. See also, for background, Macromolecules, Vol. 34, No. 19, “Effect of Short Chain Branching on the Coil Dimensions of Polyolefins in Dilute Solution”, Sun eta?., pg. 6812-6820 (2001).

The broadness of the composition distribution of the polymer may be characterized by T₇₅-T₂₅. TREE is measured using an analytical size TREE instrument (Polymerchar, Spain), with a column of the following dimensions: inner diameter (ID) 7.8 mm, outer diameter (OD) 9.53 mm, and column length of 150 mm. The column may be filled with steel beads. 0.5 mL of a 4 mg/ml polymer solution in orthodichlorobenzene (ODCB) containing 2 g BHT/4 L were charge onto the column and cooled from 140° C. to −15° C. at a constant cooling rate of 1.0° C./min Subsequently, ODCB may be pumped through the column at a flow rate of 1.0 ml/min, and the column temperature may be increased at a constant heating rate of 2° C./min to elute the polymer. The polymer concentration in the eluted liquid may then be detected by means of measuring the absorption at a wavenumber of 2941 cm⁻¹ using an infrared detector, The concentration of the ethylene-c -olefin copolymer in the eluted liquid may be calculated from the absorption and plotted as a function of temperature. As used herein. T₇₅-T₂₅ values refer to where T₂₅ is the temperature in degrees Celsius at which 25% of the eluted polymer is obtained and T₇₅ is the temperature in degrees Celsius at which 75% of the eluted polymer is obtained via a TREF analysis. For example, in an embodiment, the polymer may have a T₇₅-T₂₅ value from 5 to 10, alternatively, a T₇₅-T₂₅ value from 5.5 to 10, and alternatively, a T₇₅-T₂₅ value from 5.5 to 8, alternatively, a T₇₅-T₂₅ value from 6 to 10, and, alternatively, a T₇₅-T₂₅ value from 6 to 8, where T₂₅ is the temperature in degrees Celsius at which 25% of the eluted polymer is obtained and T₇₅ is the temperature in degrees Celsius at which 75% of the el uted polymer is obtained via temperature rising elution fractionation (TREF).

### First Polyethylene Polymer

The first polyethylene polymer comprises from 70.0 wt % to 100.0 wt % of units derived from ethylene. The lower limit on the range of ethylene content may be from 70.0 wt %, 75,0 wt %, 80.0 wt %, 85.0 wt %, 90.0 wt %, 92.0 wt %, 94,0 wt %, 95.0 wt %, 96.0 wt %, 97,0 wt %, 98.0 wt %, or 99.0 wt % based on the wt % of polymer units derived from ethylene. The first polyethylene polymer may have an upper ethylene limit of 80.0 wt %, 85.0 wt %, 90.0 wt %, 92.0 wt %, 94.0 wt %, 95.0 wt %, 96.0 wt %, 97.0 wt %, 98.0 wt %, 99.0 wt %, 99.5 wt %, or 100.0 wt %, based on polymer units derived from ethylene. For the first polyethylene polymer, it may have less than 30.0 wt % of polymer units derived from a C₃- C₂₀ olefin, preferably, an alpha-olefin, e.g., hexene or octene. The lower limit on the range of C₃-C₂₀ olefin-content may be 25.0 wt %, 20.0 wt %, 15.0 wt %, 10.0 wt %, 8.0 wt %, 6.0 wt %, 5.0 wt %, 4.0 wt %, 3.0 wt %, 2.0 wt %, 1.0 wt %, or 0.5 wt %, based on polymer units derived from the C₃-C₂₀ olefin. The upper limit on the range of C₃-C₂₀ olefin-content may he 20.0 wt %, 15.0 wt %, 10.0 wt %, 8.0 wt %, 6.0 wt %, 5.0 wt %, 4.0 wt %, 3.0 wt %, 2.0 wt %, or 1.0 wt %, based on polymer units derived from the C₃ to C₂₀ olefin, Any of the lower limits may be combined with any of the upper limits to form a range. Comonomer content is based on the total content of all monomers in the first polyethylene polymer.

In a class of embodiments, the first polyethylene polymer may have a branching index (as defined below) of g′ᵥᵢₛ≥0.98, 0.985, ≥0.99, ≥0.995, or 1.0, for example, from 0.98 to 1.0, from 0.985 to 1.0, from 0.985 to 0.995, from 0.98 to 0.995, from 0.98 to 0.99, indicating a substantially linear structure of the molecular chain.

The first polyethylene polymer may have a Composition Distribution Breadth Index (CDBI) of less than about 50%, or less than about 45%, or less than about 40%, or less than about 35%.

In some embodiments, the first polyethylene polymers may have a density in accordance with ASTM D-4703 and ASTM D-1505/ISO 1183 of from about 0.910 to less than about 0.940 g/cm³, from about 0.910 to about 0.935 g/cm³, from about 0.910 to about 0.930 g/cm³, from about 0.910 to about 0.925 g/cm³, from about 0.910 to about 0,923 g/cm³, from about 0.910 to about 0.920 g/cm³, from about 0.912 to about 0.919 g/cm³, from about 0.912 to about 0.918 g/cm³, from about 0.914 to about 0.918 g/cm³, or from about 0.915 to about 0.918 g/cm³.

The weight average molecular weight (M_{w}) of the first polyethylene polymers may be from about 15,000 to about 400,000 g/mol, from about 20,000 to about 250,000 g/mol, from about 20,000 to about 200,000 g/mol, from about 25,000 to about 150,000 g/mol, from about 150,000 to about 400,000 g/mol, from about 200,000 to about 400,000 g/mol, or from about 250,000 to about 350,000 g/mol.

The first polyethylene polymers may have a molecular weight distribution (MWD) or (M_{w}/Mₙ) of from about 1.5 to about 5.0, from about 2.0 to about 4.0, from about 3.0 to about 4.0, or from about 2.5 to about 4.0.

The first polyethylene polymers may have a z-average molecularweight (M_{z}) to weight average molecular weight (M_{w}) greater than about 1.5, or greater than about 1.7, or greater than about 2,0. In some embodiments, this ratio is from about 1.7 to about 3.5, from about 2.0 to about 3.0, or from about 2.2 to about 3.0.

The first polyethylene polymers may have a melt index (MI) or (I_{2.16}) as measured by ASTM D-1238-E (190° C./2.16 kg) of about 0.1 g/10 min to about 5.0 g/10 min, about 0.1 g/10 min to about 3.0 g/10 min, about 0.1 g/10 min to about 2.0 g/10 min, about 0.1 g/10 min to about 1.2 g/10 min, about 0.2 g/10 min to about 1.5 g/10 min, about 0.2 g/10 min to about 1.1 g/10 min, about 0.3 g/10 min to about 1.0 g/10 min, about 0.4 g/10 min to about 1.0 g/10 min, about 0.5 g/10 min to about 1.0 g/10 min, about 0.6 g/10 min to about 1,0 g/10 min, about 0.7 g/10 min to about 1.0 g/10 min, or about 0.75 g/10 min to about 0.95 g/10 min.

The first polyethylene polymers may have a melt index ratio (MIR) (I_{21.6}/I_{2.16}) (as defined below) of from about 20.0 to about 35.0, from about 22 to about 38, from about 20 to about 32, from about 25 to about 32 or from about 28 to about 31.

In a class of embodiments, the first polyethylene polymers may contain less than 5.0 ppm by weight (wppm) hafnium, less than 2.0 wppm hafnium, less than 1.5 wppm hafnium, or less than 1.0 wppm hafnium. In other embodiments, the first polyethylene polymers may contain from about 0.01 wppm to about 2 wppm hafnium, from about 0.01 wppm to about 1.5 wppm hafnium, or from about 0.01 wppm to about 1.0 wppm hafnium.

Typically, the amount of hafnium is greater than the amount of zirconium in the first polyethylene polymer. In a particular class of embodiments, the ratio of hafnium to zirconium (wppm/wppm) is at least about 1.0, at least about 2.0, at least about 5.0, at least about 10.0, at least about 15, at least about 17.0, at least about 20.0, at least about 25.0, at least about 50.0, at least about 100.0, at least about 200.0, or at least about 500.0 or more. While zirconium generally is present as an impurity in hafnium, it will be realized in some embodiments where particularly pure hafnium-containing catalysts are used, the amount of zirconium may be extremely low, resulting in an virtually undetectable or undetectable amount of zirconium in the first polyethylene polymer. Thus, the upper limit on the ratio of hafnium to zirconium in the polymer may be quite large.

In several classes of embodiments, the first polyethylene polymers may have at least a first peak and a second peak in a comonomer distribution analysis, wherein the first peak has a maximum at a log(M_{w}) value of from 4.0 to 5.4, or from 4.3 to 5.0, or from 4.5 to 4.7; and a TREF elution temperature of from 70.0° C. to 100.0° C., or from 80.0° C. to 95.0° C., or from 85.0° C. to 90.0° C. The second peak in the comonomer distribution analysis has a maximum at a log(M_{w}) value of 5.0 to 6.0, 5.3 to 5.7, or 5.4 to 5.6; and a TREF elution temperature of 40.0° C. to 60.0° C., 45.0° C. to 60.0° C., or 48.0° C. to 54.0° C.

In any of the embodiments described above, the first polyethylene polymer may have one or more of the following properties: a melt index (MI) (190° C./2.16 kg) of from about 0.1 g/10 min to about 5.0 g/10 min; a melt index ratio (MIR) of from about 25 to about 32; a M_{w} of from about 20,000 to about 200,000 g/mol; a M_{w}/Mₙ of from about 2.0 to about 4.5; and a density of from about 0.910 to about 0.920 g/cms. In any of these embodiments, the amount of hafnium is greater than the amount of zirconium and a ratio of hafnium to zirconium (wppm/wppm) may be at least about 2.0, at least about 10.0, at least about 15.0, at least about 17.0, at least about 20.0, or at least about 25.0.

In several of the classes of embodiments described above, the first polyethylene polymer may have an orthogonal comonomer distribution. The term “orthogonal comonomer distribution” is used herein to mean across the molecular weight range of the ethylene polymer, comonomer contents for the various polymer fractions are not substantially uniform and a higher molecular weight fraction thereof generally has a higher comonomer content than that of a lower molecular weight fraction. The term “substantially uniform comonomer distribution” is used herein to mean that comonomer content of the polymer fractions across the molecular weight range of the ethylene-based polymer vary by <10.0 wt %. In sonic embodiments, a substantially uniform comonomer distribution may refer to <8.0 wt %, <5.0 wt %, or <2.0 wt %. Both a substantially uniform and an orthogonal comonomer distribution may be determined using fractionation techniques such as gel permeation chromatography-differential viscometry (GPC-DV), temperature rising elution fraction-differential viscometry (TREF-DV) or cross-fractionation techniques.

Materials and processes for making the first polyethylene polymers have been described in, for example, U.S. Pat. No. 6,956,088, particularly Example 1; U.S. Patent Application Publication No. 2009/0297810, particularly Example 1; U.S. Patent Application Publication No. 2015/0291748, particularly PE1-PE5 in the Examples; and WO 2014/099356, particularly PE3 referenced on page 12 and in the Examples, including the use of a silica supported hafnium transition metal metallocene/methylalumoxane catalyst system described in, for example, U.S. Pat. Nos. 6,242,545 and 6,248,845, particularly Example 1. While the polymerization processes are described therein, certain features are reproduced here for convenience.

As described therein, polymerization catalyst in a supported form, for example deposited on, bonded to, contacted with, or incorporated within, adsorbed or absorbed in, or on, a support or carrier may be used. The metallocene catalyst may be introduced onto a support by slurrying a presupported activator in oil, a hydrocarbon such as pentane, solvent, or non-solvent, then adding the inetallocene as a solid while stirring. The inetallocene may be finely divided solids. Although the metallocene is typically of very low solubility in the diluting medium, it is found to distribute onto the support and be active for polymerization. Very low solubilizing media such as mineral oil (e.g., Kaydo™ or Drakol™) or pentane may be used. The diluent can be filtered off and the remaining solid shows polymerization capability much as would be expected if the catalyst had been prepared by traditional methods such as contacting the catalyst with methylalunioxane in toluene, contacting with the support, followed by removal of the solvent. If the diluent is volatile, such as pentane, it may be removed under vacuum or by nitrogen purge to afford an active catalyst. The mixing time may be greater than 4 hours, but shorter times are suitable.

The substituted bulky ligand hafnium transition metal metallocene-type catalyst compounds and catalyst systems discussed above are suited for the polymerization of monomers, and optionally one or more comonomers, in any polymerization process, solution phase, gas phase, or slurry phase. Typically in a gas phase polymerization process a continuous cycle is employed where in one part of the cycle of a reactor, a cycling gas stream, otherwise known as a recycle stream or fluidizing medium, is heated in the reactor by the heat of polymerization. This heat is removed in another part of the cycle by a cooling system external to the reactor. (See for example U.S. Pat. Nos, 4,543,399; 4,588,790; 5,028,670; 5,317,036; 5,352,749; 5,405,922; 5,436,304; 5,453,471 ; 5,462,999; 5,616,661; and 5,668,228, all of which are fully incorporated herein by reference).

Generally, in a gas fluidized bed process for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. The reactor pressure may vary from 100-500 psig (680-3448 kPag), or in the range of from 200-400 psig (1379-2759 kPag), or in the range of from 250-350 psig (1724- 2414 kPag). The reactor temperature may vary between 60-120° C. or 60-115° C., or in the range of from 70-110° C., or in the range of from 70-95° C., or 70-90° C. The productivity of the catalyst or catalyst system is influenced by the main monomer partial pressure. The mole percentage of the main monomer, ethylene, is from 25.0-90.0 mole %, or 50.0-90.0 mole %, or 70.0-85.0 mole %, and the monomer partial pressure is in the range of from 75-300 psia (517-2069 kPa), or 100-275 psia (689-1894 kPa), or 150-265 psia (1034-1826 kPa), or 200- 250 psia (1378-1722 kPa), typical conditions in a gas phase polymerization process.

Other gas phase processes contemplated by the process of the invention include those described in U.S. Pat. Nos. 5,627,242; 5,665,818; and 5,677,375, and European Applications EP-A-0 794 200; EP-A-0 802 202; and EP-B-0 634 421, all of which are herein fully incorporated by reference.

It may be beneficial to operate in the substantial absence of or essentially free of any scavengers, such as triethylaluminum, trimethylaluminum, triisobutylaluminum, and trin-hexylaluminum and diethyl aluminum chloride and the like. This process is described in PCT Publication No. WO 96/08520, which is herein fully incorporated by reference.

A slurry polymerization process generally uses pressures in the range of 1 to 50 atmospheres and even greater and temperatures in the range of from 0 to 200° C. In a slurry polymerization, a suspension of solid, particulate polymer is formed in a liquid polymerization medium to which ethylene and comonomers and often hydrogen along with catalyst are added. The liquid employed in the polymerization medium can be alkane or cycloalkane, or an aromatic hydrocarbon such as toluene, ethylbenzene, or xylene. The medium employed should be liquid under the conditions of polymerization and relatively inert. Hexane or isobutane medium may be employed.

The first polyethylene polymers may be prepared by a process referred to as a particle form, or slurry process where the temperature is kept below the temperature at which the polymer goes into solution. Such technique is well known in the art, see for instance U.S. Pat. No. 3,248,179, which is fully incorporated herein by reference. The temperature in the particle form process is within the range of 85 -110° C. (185-230° F.). Two polymerization methods for the slurry process are those employing a loop reactor and those utilizing a plurality of stirred reactors in series, parallel, or combinations thereof. Non-limiting examples of slurry processes include continuous loop or stirred tank processes. Also, other examples of slurry processes are described in U.S. Pat. No. 4,613,484, which is herein fully incorporated by reference.

Typical reactors for producing ethylene-based polymers are capable of producing greater than 500 lbs/hr (227 kg/hr) to 200,000 lbs/hr (90,900 kg/hr) or higher of polymer, or greater than 1000 lbs/hr (455 kg/hr), or greater than 10,000 lbs/hr (4540 kg/hr), or greater than 25,000 lbs/hr (1 1,300 kg/hr), or greater than 35,000 lbs/hr (15,900 kg/hr), or greater than 50,000 lbs/hr (22,700 kg/hr), or greater than 65,000 lbs/hr (29,000 kg/hr) to greater than 100,000 lbs/hr (45,500 kg/hr).

Persons having skill in the art will recognize that the above-described processes may he tailored to achieve desired first polyethylene polymers. For example, comonomers to ethylene concentration or flow rate ratios are commonly used to control resin density. Similarly, hydrogen to ethylene concentrations or flow rate ratios are commonly used to control resin molecular weight. In both cases, higher levels of a modifier results in lower values of the respective resin parameter. Gas concentrations may be measured by, for example, an on-line gas chromatograph or similar apparatus to ensure relatively constant composition of recycle gas streams.

Additionally, the use of a process continuity aid, while not required, may he desirable in preparing the ethylene-based polymers, particularly for large-scale production. Such continuity aids are well known to persons of skill in the art and include, for example, metal stearates.

The first polyethylene polymers can commercially available from ExxonMobil Chemical Company, Houston, Tex., and sold under Exceed™ XP metallocene polyethylene (mPE). Exceed XP™ mPE offers step-out performance with respect to, for example, dart drop impact strength, flex-crack resistance, and machine direction (MD) tear, as well as maintaining stiffness at lower densities. Exceed XP™ mPE also offers optimized solutions for a good balance of melt strength, toughness, stiffness, and sealing capabilities which makes this family of polymers well-suited for blown film/sheet solutions.

### Second Polyethylene Polymers

The second polyethylene polymers are ethylene-based polymers having about 99.0 to about 80.0 wt %, about 99.0 to about 85.0 wt %, about 99.0 to about 87.5 wt %, about 99.0 to about 90.0 wt %, about 99.0 to about 92.5 wt %, about 99.0 to about 95.0 wt %, or about 99.0 to about 97.0 wt %, of polymer units derived from ethylene and about 1.0 to about 20.0 wt %, about 1.0 to about 15.0 wt %, about 1.0 to about 12.5 wt %, about 1.0 to about 10.0 wt %, about 1.0 to about 7.5 wt %, about 1.0 to about 5.0 wt %, or about 1.0 to about 3.0 wt % of polymer units derived from one or more C₃ to C₂₀ α-olefin comonomers, preferably C₃ to C₁₀ α-olefins, and more preferably C₄ to C₈ α-olefins. The α-olefin comonomer may be linear, branched, cyclic and/or substituted, and two or more comonomers may be used, if desired. Examples of suitable comonomers include propylene, butene, 1-pentene; 1-pentene with one or more methyl, ethyl, or propyl substituents; 1-hexene; 1-hexene with one or more methyl, ethyl, or propyl substituents; 1-heptene; 1- heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene. Particularly suitable comonomers include 1-butene, 1-hexene, and 1-octene, 1-hexene, and mixtures thereof.

In an embodiment of the invention, the second polyethylene polymer comprises from about 8 wt % to about 15 wt %, of C₃-C₁₀ α-olefin derived units, and from about 92 wt % to about 85 wt % ethylene derived units, based upon the total weight of the polymer.

In another embodiment of the invention, the second polyethylene polymer comprises from about 9 wt % to about 12 wt %, of C₃-C₁₀ α-olefin derived units, and from about 91 wt % to about 88 wt % ethylene derived units, based upon the total weight of the polymer.

The second polyethylene polymers may have a melt index (MI), I_{2.16} or simply I₂ for shorthand according to ASTM D1238, condition F (190° C./2.16 kg) reported in grams per 10 minutes (g/10 min), of ≥about 0.10 g/10 min, e.g., ≥about 0.15 g/10 min, ≥about 0.18 g/10 min, ≥about 0.20 g/10 min, ≥about 0.22 g/10 min, ≥about 0.25 g/10 min, ≥about 0.28, or ≥about 0.30 g/10 min. Additionally, the second polyethylene polymers may have a melt index (I_{2.16})≤about 3.0 g/10 min, ≤about 2.0 g/10 min, ≤about 1.5 g/10 min, ≤about 1.0 g/10 min, ≤about 0.75 g/10 min, ≤about 0.50 g/10 min, ≤about 0.40 g/10 min, ≤about 0.30 g/10 min, ≤about 0.2.5 g/10 min, ≤about 0.22 g/10 min, ≤about 0.20 g/10 min, ≤about 0.18 g/10 min, or ≤about 0.15 g/10 min. Ranges expressly disclosed include, but are not limited to, ranges formed by combinations any of the above-enumerated values, e.g., from about 0.1 to about 3.0, about 0.2 to about 2.0, about 0.2 to about 0.5 g/10 min, about 0.5 to about 1.0 g/10 min, etc.

The second polyethylene polymers may also have High Load Melt Index (HLMI), I_{21.6} or I₂₁ for shorthand, measured in accordance with ASTM D-1238, condition F (190° C./21.6 kg). For a given polymer having an MI and MIR as defined herein, the HLMI is fixed and can be calculated in accordance with the following paragraph.

The second polyethylene polymers may have a Melt Index Ratio (MIR) which is a dimensionless number and is the ratio of the high load melt index to the melt index. or I_{21.6}/I_{2.16} as described above. The MIR of the second polyethylene polymers may be from about 25 to about 80, alternatively, from about 25 to about 60, alternatively, from about 30 to about 55, and alternatively, from about 35 to about 50.

The second polyethylene polymers may have a density ≥about 0.905 g/cm³, ≥about 0.910 g/cm³, ≥about 0.912 g/cm³, ≥about 0.913 g/cm³, ≥about 0.915 g/cm³, ≥about 0.916 g/cm³, ≥about 0.917 g/cm³, ≥about 0.918 g/cm^{3,} or ≥about 0.920 g/cm³. Additionally or alternatively, second polyethylene polymers may have a density ≤about 0.945 g/cm³, e g., ≤about 0.940 g/cm³, ≤about 0.937 g/cm³, ≤about 0.935 g/cm³, ≤about 0.930 g/cm³, ≤about 0.925 g/cm³, ≤about 0.920 g/cm³, or ≤about 0.918 g/cm³. Ranges expressly disclosed include, but are not limited to, ranges formed by combinations any of the above-enumerated. values, e.g., from about 0.905 to about 0.945 g/cm³, from about 0.910 to about 0.945 g/cm³, from about 0.915 to about 0.945 g/cm³, from about 0.916 to about 0.945 g/c1n³, from about 0.92.0 to about 0.945 g/cm³, or from about 0.915 to about 0.935 g/cm³. Density is determined using chips cut from plaques compression molded in accordance with ASTM D-1928 Procedure C, aged in accordance with ASTM D-618 Procedure A, and measured as specified by ASTM D-1505.

Typically, although not necessarily, the second polyethylene polymers may have a molecular weight distribution (MWD, defined as M_{w}/Mₙ) of about 2.5 to about 5.5, preferably about 3.0 to about 4.0.

The melt strength of a polymer at a particular temperature may be determined with a Gottfert Rheotens Melt Strength Apparatus. To determine the melt strength, a polymer melt strand extruded from the capillary die is gripped between two counter-rotating wheels on the apparatus. The take-up speed is increased at a constant acceleration of 2.4 mm/sec².

The maximum pulling force (in the unit of cN) achieved before the strand breaks or starts to show draw-resonance is determined as the melt strength. The temperature of the rheometer is set at 190° C. The capillary die has a length of 30 mm and a diameter of 2 min The polymer melt is extruded from the die at a speed of 10 mm/sec. The distance between the die exit and the wheel contact point should be 122 mm. The melt strength of polymers of embodiments of invention may be in the range from about 1 to about 100 cN. about 1 to about 50 cN, about 1 to about 25 cN, about 3 to about 15 cN, about 4 to about 12 cN, or about 5 to about 10 cN.

The second polyethylene polymers (or films made therefrom) may also be characterized by an averaged 1% secant modulus (M) of from 10,000 to 60,000 psi (pounds per square inch), alternatively, from 20,000 to 40,000 psi, alternatively, from 20,000 to 35,000 psi, alternatively, from 25,000 to 35,000 psi, and alternatively, from 28,000 to 33,000 psi, and a relation between M and the dart drop impact strength in g/mil (DIS) complying with formula (A):

DIS≥0.8*[100+e^{(11.71-0.000268M+2.183×10}^{^{−9}}^{M}^{²}⁾], (A),

where “e” represents 2.7183, the base Napierian logarithm, M is the averaged modulus in psi, and DIS is the 26 inch dart impact strength. The DIS is preferably from about 120 to about 1000 g/mil, even more preferably, from about 150 to about 800 g/mil.

The second polyethylene polymer can have a guts of less than about 0.98, for example from about 0.65 to about 0.98, from about 0.65 to about 0.97, from about 0.7 to about 0.97, from about 0.75 to about 0.98, from about 0.80 to about 0.97, from about 0.85 to about 0.97, from about 0.90 to about 0.97, from about 0.93 to about 0.97, or from about 0.95 to about 0.98, or any ranges between the above values so long as the lower limit is less than the upper limit.

The second polyethylene polymers can have a Composition Distribution Breadth Index (CDBI) of greater than about 50 wt %, e.g., greater than about 70%, preferably greater than about 80.0%, preferably greater than about 85.0%, preferably greater than about 90.0%; such as from about 70.0% to about 98%, from about 80.0% to about 95.0%, or from about 85.0% to about 90,0%.

The second polyethylene polymers may be made by any suitable polymerization method including solution polymerization, slurry polymerization, supercritical, and gas phase polymerization using supported or unsupported catalyst systems, such as a system incorporating a metallocene catalyst.

As used herein, the term “metallocene catalyst” is defined to comprise at least one transition metal compound containing one or more substituted or unsubstituted cyclopentadienyl moiety (Cp) (typically two Cp moieties) in combination with a Group 4, 5, or 6 transition metal, such as, zirconium, hafnium, and titanium.

Metallocene catalysts generally require activation with a suitable co-catalyst, or activator, in order to yield an “active metallocene catalyst”, i.e., an organometallic complex with a vacant coordination site that can coordinate, insert, and polymerize olefins. Active catalyst systems generally include not only the metallocene complex, but also an activator, such as an alumoxane or a derivative thereof (preferably methyl alumoxane), an ionizing activator, a Lewis acid, or a combination thereof. Alkylalumoxanes (typically methyl alumoxane and modified methylalumoxanes) are particularly suitable as catalyst activators. The catalyst system may be supported on a carrier, typically an inorganic oxide or chloride or a resinous material such as, for example, polyethylene or silica.

Zirconium transition metal metallocene-type catalyst systems are particularly suitable. Non-limiting examples of metallocene catalysts and catalyst systems useful in practicing the present invention include those described in, U.S. Pat. Nos. 5,466,649, 6,476,171, 6,225,426, and 7,951,873, and in the references cited therein, all of which are fully incorporated herein by reference. Particularly useful catalyst systems include supported dimethylsityl bis(tetrahydroindenyl) zirconium dichloride.

Supported polymerization catalyst may be deposited on, bonded to, contacted with, or incorporated within, adsorbed or absorbed in, or on, a support or carrier. In another embodiment, the metallocene is introduced onto a support by slurrying a presupported activator in oil, a hydrocarbon such as pentane, solvent, or non-solvent, then adding the metallocene as a solid while stirring. The metallocene may be finely divided solids. Although the metallocene is typically of very low solubility in the diluting medium, it is found to distribute onto the support and be active for polymerization. Very low solubilizing media such as mineral oil (e.g., Kaydo™ or Drakol™) or pentane may be used. The diluent can be filtered off and the remaining solid shows polymerization capability much as would be expected if the catalyst had been prepared by traditional methods such as contacting the catalyst with methylalumoxane in toluene, contacting with the support, followed by removal of the solvent. If the diluent is volatile, such as pentane, it may be removed under vacuum or by nitrogen purge to afford an active catalyst. The mixing time may be greater than 4 hours, but shorter times are suitable.

Typically in a gas phase polymerization process, a continuous cycle is employed where in one part of the cycle of a reactor, a cycling gas stream, otherwise known as a recycle stream or fluidizing medium, is heated in the reactor by the heat of polymerization. This heat is removed in another part of the cycle by a cooling system external to the reactor. (See e.g., U.S. Pat. Nos. 4,543,399, 4,588,790, 5,028,670, 5,317,036, 5,352,749, 5,405,922, 5,436,304, 5,453,471, 5,462,999, 5,616,661, and 5,668,228.) To obtain the second polyethylene polymers, individual flow rates of ethylene, comonomer, and hydrogen should be controlled and adjusted to obtain the desired polymer properties.

Suitable commercial polymers for the second polyethylene polymer are available from ExxonMobil Chemical Company as Enablem metallocene polyethylene (mPE) resins.

### Additional Polyethylene Polymers

Additional polymers may be combined with the polyethylene polymer described above in a blend in a monolayer film or in one or more layers in a multilayer film or structure. The additional polymers may include other polyolefin polymers such as the following ethylene-based and/or propylene-based polymers.

### First Additional Polymers

The first additional polymers are ethylene-based polymers comprising ≥50.0 wt % of polymer units derived from ethylene and ≤50.0 wt % preferably 1.0 wt % to 35.0 wt %, even more preferably 1 to 6 wt % of polymer units derived from a C₃ to C₂₀ alpha-olefin comonomer (for example, hexene or octene).

The first additional polymer may have a density of ≥about 0,910 g/cm³, ≥about 0.915 g/cm³ ≥about 0.920 g/cm³, ≥about 0.925 g/cm³, ≥about 0.930 g/cm³, or ≥about 0.940 g/cm³. Alternatively, the second polyethylene polymer may have a density of ≤about 0.950 g/cm³, e.g,, ≤about 0.940 g/cm³, ≤about 0.930 g/cm³, ≤about 0.925 g/cm³, ≤about 0.920 g/cm³, or ≤about 0.915 g/cm³. Ranges expressly disclosed include ranges formed by combinations any of the above-enumerated values, e.g., 0.910 to 0.950 g/cm³, 0.910 to 0.930 g/cm³, 0.910 to 0.925 g/cm³, etc. Density is determined using chips cut from plaques compression molded in accordance with ASTM D-1928 Procedure C, aged in accordance with ASTM D-618 Procedure A, and measured as specified by ASTM D-1505.

The first additional polymer may have a melt index (I_{2.16}) according to ASTM D1238 (190° C./2.16 kg) of ≥about 0.5 g/10 min., e.g.. ≥about 0.5 g/10 min., ≥about 0.7 g/10 min., ≥about 0.9 g/10 min., ≥about 1.1 g/10 min., ≥about 1.3 g/10 min., ≥about 1.5 g/10 min. or ≥about 1.8 g/10 min. Alternatively, the melt index (I_{2.16}) may be ≤about 8.0 g/10 min., ≤about 7.5 g/10 min., ≤about 5.0 g/10 min., ≤about 4.5 g/10 min., ≤about 3.5 g/10 min., ≤about 3.0 g/10 min., ≤about 2.0 g/10 min., e.g., ≤about 1.8 g/10 min., ≤about 1.5 g/10 min., ≤about 1.3 g/10 min., ≤about 1.1 g/10 min., ≤about 0.9 g/10 min., or ≤about 0.7 g/10 min., 0.5 to 2.0 g/10 min., particularly 0.75 to 1.5 g/10 min. Ranges expressly disclosed include ranges formed by combinations any of the above-enumerated values, e.g., about 0.5 to about 8.0 g/10 min., about 0.7 to about 1.8 g/10 min, about 0.9 to about 1.5 g/10 min., about 0.9 to 1.3, about 0.9 to 1.1 g/10 min, about 1.0 g/10 min., etc.

In particular embodiments, the first additional polymer may have a density of 0.910 to 0.920 g/cm³, a melt index (I_{2.16}) of 0.5 to 8.0 g/10 min., and a CDBI of 60.0% to 80.0%, preferably between 65% and 80%.

The first additional polyethylene polymers are generally considered linear. Suitable first additional polyethylene polymers are available from ExxonMobil Chemical Company under the trade name Exceed™ metallocene (mPE) resins. The MIR for Exceed materials will typically be from about 15 to about 20, such as between 25 and 32, or 28 and 31.

### Second Additional Polymers

The second additional polymers may be a copolymer of ethylene, and one or more polar comonomers or C₃ to C₁₀ α-olefins. Typically, the second additional polymer includes about 99.0 wt % to about 80.0 wt %, about 99.0 wt % to about 85.0 wt %, about 99.0 wt % to about 87.5 wt %, about 95.0 wt % to about 90.0 wt %, of polymer units derived from ethylene and about 1.0 to about 20.0 wt %, about 1.0 wt % to about 15.0 wt %, about 1.0 wt % to about 12.5 wt %, or about 5.0 wt % to about 10.0 wt % of polymer units derived from one or more polar comonomers, based upon the total weight of the polymer. Suitable polar comonomers include, but are not limited to: vinyl ethers such as vinyl methyl ether, vinyl n-butyl ether, vinyl phenyl ether, vinyl beta-hydroxy-ethyl ether, and vinyl dimethyla.mino-ethyl ether; olefins such as propylene, butene-1, cis-butene-2, trans-butene-2, isobutylene, 3,3,-dimethylbutene-1, 4-methylpentene-1, octene-1, and styrene; vinyl type esters such as vinyl acetate, vinyl butyrate, vinyl pivalate, and vinylene carbonate; haloolefins such as vinyl fluoride, vinylidene fluoride, tetrafluoroethylene, vinyl chloride, vinylidene chloride, tetrachloroethylene, and chlorotrifluoroethylene; acrylic-type esters such as methyl acrylate, ethyl acrylate, n-butyl acrylate, t-butyl acrylate, 2-ethylhexyl acrylate, alpha-cyanoisopropyl acrylate. beta-cyanoethyl acrylate, o-(3-phenylpropan-1,3,- dionyl)phenyl acrylate, methyl methacrylate, n-butyl methacrylate, t-butyl methacrylate, cyclohexyl methacrylate, 2-ethylhexyl methacrylate, methyl methacrylate, glycidyl methacrylate, beta-hydroxethyl methacrylate, beta-hydroxpropyl methacrylate, 3-hydroxy-4- carbo-methoxy-phenyl methacrylate, N,N-dimethylaminoethyl methacrylate, t-butylaminoethyl methacrylate, 2-(1-aziridinyl)ethyl methacrylate, diethyl fumarate, diethyl maleate, and methyl crotonate other acrylic-type derivatives such as acrylic acid, methacrylic acid, crotonic acid, maleic acid, methyl hydroxy maleate, itaconic acid, acrylonitrile, fumaronitrile, N,N-dimethylacrylamide, N-isopropyl acrylamide, N-t-butylacrylamide, N- phenylacry la.mi de, di acetone acrylamide, methacrylamide, N-phenylmethacrylatnide, N-ethylmaleimide, and maleic anhydride and other compounds such as allyl alcohol, vinyitrimethylsilane, vinyltriethoxysilane, N-vinylcarbazole, N-vinyl-N-methylacetamide, vinyldibutylphosphine oxide, vinyldiphenylphosphine oxide, bis-(2-chloroethyl) vinylphosphonate, and vinyl methyl sulfide.

In some embodiments, the second additional polymer is an ethylene/vinyl acetate copolymer having about 2.0 wt % to about 15.0 wt %, typically about 5.0 wt % to about 10.0 wt %, polymer units derived from vinyl acetate, based on the amounts of polymer units derived. from ethylene and vinyl acetate (EVA). In certain embodiments, the EVA resin can further include polymer units derived from one or more comonomer units selected from propylene, butene, 1-hexene, 1-octene, and/or one or more dienes,

Suitable dienes include, for example, 1,4-hexadiene, 1,6-octadiene, 5 methyl-1, 4-hexadiene, 3,7-dimethyl-1,6-octadiene, dicyclopentadiene (DCPD), ethylidene norbornene (ENB), norbornadiene, 5-vinyl-2-norbornene (VNB), and combinations thereof.

Suitable second additional polymers include Escorene™ Ultra EVA resins, Escor™ EAA resins, ExxonMobil™ EnBA resins, and Optema™ EMA resins available from ExxonMobil Chemical Company, Houston, Tex.

### Other Additional Polymers

A third additional polymer can be generally heterogeneously branched ethylene polymers. The term “heterogeneously branched ethylene polymer” refers to an polymer having polymer units derived from ethylene and preferably at least one C₃-C₂₀ alpha-olefin and having a CDBI <about 50.0%. Typically, such polymers are the result of a Ziader-Natta polymerization process. Such polymers are also referred to as Linear Low Density Polyethylene Polymers or LDPEs, more particularly sometimes as ZN LLDPEs.

Heterogeneously branched ethylene polymers differ from the homogeneously branched ethylene polymers primarily in their branching distribution. For example, heterogeneously branched LLDPE polymers have a distribution of branching, including a highly branched portion (similar to a very low density polyethylene), a medium branched portion (similar to a medium branched polyethylene) and an essentially linear portion (similar to linear homopolymer polyethylene). The amount of each of these fractions varies depending upon the whole polymer properties desired. For example, a linear homopolymer polyethylene polymer has neither branched nor highly branched fractions, but is linear.

Heterogeneously branched ethylene polymer polymers typically have a CDBI <about 500%, preferably <45.0%, <40.0%, <35.0%, <30.0%, <25.0%, or <20.0%. In particular embodiments the CDBI of the heterogeneously branched ethylene polymer is about 20.0 to <about 50.0%, 20.0 to 45.0%, 20.0 to 35.0%, 20.0 to 30.0%, 20.0 to 25.0%, 25.0 to 30.0%, 25.0 to 35.0%, 25.0 to 40.0%, 25.0 to 45.0%, 30.0 to 35.0%, 30.0 to 40,0%, 30.0 to 45.0%, 30.0 to <50.0%, 35.0 to 40.0%, 35.0 to <50.0%, 40.0 to 45.0%, or 40.0 to <50.0%.

The heterogeneously branched ethylene polymer typically comprises 80 to 100 mole % of polymer units derived from ethylene and 0 to 20.0 mole % of polymer units derived from at least one C₃ to C₂₀ alpha-olefin, preferably the alpha olefin has 4 to 8 carbon atoms. The content of comonomer is determined based on the mole fraction based on the content of all monomers in the polymer.

The content of polymer units derived from alpha-olefin in the heterogeneously branched ethylene polymer may be any amount consistent with the above ranges for ethylene. Some preferred amounts are about 2.0 to about 20.0 mole %, about 2.0 to about 15.0 mole %, or about 5.0 to about 10.0 mole %, particularly where the polymer units are derived from one or more C₄-C₈ alpha-olefins, more particularly butene-1, hexene-1, or octene-1.

Heterogeneously branched ethylene polymers may have a density ≤0.950 g/cm³, preferably ≤0.940 g/cm³, particularly from about 0.915 to about 0.950 g/cm³, preferably about 0.920 to 0.940 g/cm³.

The melt index, I_{2.16}, according to ASTM D-1238-E (190° C./2.16 kg) of the heterogeneously branched ethylene polymer is generally from about 0.1 g/10 min to about 100.0 g/10 min,

Suitable heterogeneously branched ethylene polymers and other polyethylene polymers include ExxonMobill™ Linear Low Density Polyethylene (LLDPE) and ExxonMobil™ NTX Super hexene copolymer available from ExxonMobil Chemical Company, Houston, Tex.

A fourth additional polyethylene polymer may also be present as High Density Polyethylene (HDPE). The HDPE may be unimodal or bimodal/multimodal and have a narrow molecular weight distribution (MWD) or broad MWD.

A fifth additional polyethylene polymer may also be present as Low Density Polyethylene made from a High Pressure Polymerization Process. Suitable resins include Nexxstar™ resins available from ExxonMobil and other LDPE's.

Propylene-based polymers are also contemplated. A suitable propylene-based polymer or elastomer (“PBE”) comprises propylene and from about 5 wt % to about 25 wt % of one or more comonomers selected from ethylene and/or C₄-C₁₂ α-olefins, In one or more embodiments, the α-olefin comonomer units may be derived from ethylene, butene, pentene, hexene, 4-methyl-1-pentene, octene, or decene. The embodiments described below are discussed with reference to ethylene as the α-olefin comonomer, but the embodiments are equally applicable to other copolymers with other α-olefin comonomers. In this regard, the copolymers may simply be referred to as propylene-based polymers with reference to ethylene as the α-olefin.

In one or more embodiments, the PBE may include at least about 2 wt %, at least about 3 wt %, at least about 4 wt %, at least about 5 wt %, at least about 6 wt %, at least about 7 wt %, or at least about 8 wt %, or at least about 9 wt %, or at least about 10 wt %, or at least about 12 wt % ethylene-derived units. In those or other embodiments, the PBE may include up to about 30 wt %, or up to about 25 wt %, or up to about 22 wt %, or up to about 20 wt %, or up to about 19 wt %, or up to about 18 wt %, or up to about 17 wt % ethylene-derived units, where the percentage by weight is based upon the total weight of the propylene-derived and α-olefin derived units. Stated another way, the PBE may include at least about 70 wt %, or at least about 75 wt %, or at least about 80 wt %, or at least about 81 wt % propylene-derived units, or at least about 82 wt % propylene-derived units, or at least about 83 wt % propylene-derived units; and in these or other embodiments, the PBE may include up to about 95 wt %, or up to about 94 wt %, or up to about 93 wt %, or up to about 92 wt%, or up to about 90 wt %, or up to about 88 wt % propylene-derived units, where the percentage by weight is based upon the total weight of the propylene-derived and α-olefin derived units. In certain embodiments, the PBE may comprise from about 5 wt % to about 25 wt % ethylene-derived units, or from about 9 wt % to about 18 wt % ethylene-derived units.

The PBEs of one or more embodiments are characterized by a melting point (Tm), which can be determined by differential scanning calorimetry (DSC). For purposes herein, the maximum of the highest temperature peak is considered to be the melting point of the polymer. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak.

In one or more embodiments, the Tm of the PBE (as determined by DSC) is less than about 115° C., or less than about 110° C., or less than about 100° C., or less than about 95° C., or less than about 90° C.

In one or more embodiments, the PBE may be characterized by its heat of fusion (Hf), as determined by DSC. In one or more embodiments, the PBE may have an Hf that is at least about 0.5 J/g, or at least about 1.0 J/g, or at least about 1.5 J/g, or at least about 3.0 J/g, or at least about 4.0 J/g, or at least about 5.0 J/g, or at least about 6.0 J/g, or at least about 7.0 J/g. In these or other embodiments, the PBE may be characterized by an Hf of less than about 75 J/g, or less than about 70 J/g, or less than about 60 J/g, or less than about 50 J/g, or less than about 45 J/g, or less than about 40 J/g, or less than about 35 J/g, or less than about 30 J/g.

As used within this specification, DSC procedures for determining Tm and Hf include the following. The polymer is pressed at a temperature of from about 200° C. to about 230° C. in a heated press, and the resulting polymer sheet is hung, at about 23° C., in the air to cool. About 6 to 10 mg of the polymer sheet is removed with a punch die. This 6 to 10 mg sample is annealed at about 23° C. for about 80 to 100 hours. At the end of this period, the sample is placed in a DSC (Perkin Elmer Pyris One Thermal Analysis System) and cooled at a rate of about 10° C./min to about −50° C. to about −70° C. The sample is heated at a rate of about 10° C/min to attain a final temperature of about 200° C. The sample is kept at 200° C. for 5 minutes and a second cool-heat cycle is performed. Events from both cycles are recorded. The thermal output is recorded as the area under the melting peak of the sample, which typically occurs between about 0° C. and about 200° C. It is measured in Joules and is a measure of the Hr of the polymer.

The PBE can have a triad tacticity of three propylene units, as measured by ¹³C NMR, of 75% or greater, 80% or greater, 85% or greater, 90% or greater, 92% or greater, 95% or greater, or 97% or greater. In one or more embodiments, the triad tacticity may range from about 75 to about 99%, or from about 80 to about 99%, or from about 85 to about 99%, or from about 90 to about 99%, or from about 90 to about 97%, or from about 80 to about 97%. Triad tacticity is determined by the methods described in U.S. Pat. No. 7,232,871.

The PBE may have a tacticity index ranging from a lower limit of 4 or 6 to an upper limit of 8 or 10 or 12. The tacticity index, expressed herein as “m/r”, is determined by ¹³C nuclear magnetic resonance (“NMR”). The tacticity index, ink, is calculated as defined by H. N. Cheng in 17 MACROMOLECULES 1950 (1984). The designation “m” or “r” describes the stereochemistry of pairs of contiguous propylene groups, “m” referring to meso and “r” to racemic. An m/r ratio of 1.0 generally describes a syndiotactic polymer, and an m/r ratio of 2.0 an atactic material. An isotactic material theoretically may have a ratio approaching infinity, and many by-product atactic polymers have sufficient isotactic content to result in ratios of greater than 50.

In one or more embodiments, the PBE may have a % crystallinity of from about 0.5% to about 40%, or from about 1% to about 30%, or from about 5% to about 25%, determined according to DSC procedures. Crystallinity may be determined by dividing the Hf of a sample by the Hf of a 100% crystalline polymer, which is assumed to be 189 joules/gram for isotactic polypropylene or 350 joules/gram for polyethylene.

In one or more embodiments, the PBE may have a density of from about 0.85 gicm³ to about 0.92 g/cm³, or from about 0.86 g/cm³ to about 0.90 g/cm³, or from about 0.86 g/cm³ to about 0.89 g/cm³ at room temperature, as measured per the ASTM D-792.

In one or more embodiments, the PBE can have a melt index (Mi) (ASTM D-1238-E, 2.16 kg @ 190° C.), of less than or equal to about 100 g/10 min, or less than or equal to about 50 g/10 mM, or less than or equal to about 25 g/10 min, or less than or equal to about 10 g/10 min, or less than or equal to about 9.0 g/10 min, or less than or equal to about 8.0 g/10 min, or less than or equal to about 7.0 g/10 min.

In one or more embodiments, the PBE may have a melt flow rate (MFR), as measured according to ASTM D-1238-E (2.16 kg weight @ 230° C.), greater than about 1 g/10 min, or greater than about 2 g/10 min, or greater than about 5 g/10 min, or greater than about 8 g/10 min, or greater than about 10 g/10 min. In the same or other embodiments, the PBE may have an MFR less than about 500 g/10 min, or less than about 400 g/10 min, or less than about 300 g/10 min, or less than about 200 g/10 min, or less than about 100 g/10 min, or less than about 75 g/10 min, or less than about 50 g/10 min. In certain embodiments, the PBE may have an MFR from about 1 to about 100 g/10 min, or from about 2 to about 75 g/10 min, or from about 5 to about 50 g/10 min.

Suitable commercially available propylene-based polymers include Vistamaxx™ Performance Polymers from ExxonMobil Chemical Company and Versify™ Polymers from The Dow Chemical Company, Midland, Mich.

The propylene-based polymers may also include polypropylene homopolymers and/or other polypropylene copolymers. For these types of polymers, the term propylene-based polymer refers to a homopolymer, copolymer, or impact copolymer including :>50.0 mol % of polymer units derived from propylene. Some useful propylene-based polymers include those having one or more of the following properties:
1) propylene content of at least about 85 wt % (preferably at least about 90 wt %. preferably at least about 95 wt %, preferably at least about 97 wt %, preferably about 100 wt %);
2) M_{w} of about 30 to about 2,000 kg/mol (preferably 50 to 1,000 kg/mol, preferably 90 to 500 kg/mol);
3) M_{w}/Mₙ of about 1 to about 40 (preferably 1.4 to 20, preferably 1.6 to 10, preferably 1.8 to 3.5, preferably 1.8 to 2.5);
4) branching index (g′) of about 0.2 to about 2.0 (preferably 0.5 to 1.5, preferably 0.7 to 1.3, preferably 0.9 to 1.1);
5) melt flow rate (MFR) of about 1 to about 300 dg/min (preferably 5 to 150 dg/min, preferably 10 to 100 dg/min, preferably 20 to 60 dg/min);
6) melting point of at least about 100° C. (preferably at least 110° C., preferably at least 120° C., preferably at least 130° C., preferably at least 140° C., preferably at least 150° C., preferably at least 160° C., preferably at least 165° C.);
7) crystallization temperature (T_{c}, peak) of at least about 70° C. (preferably at least 90° C., preferably at least 110° C., preferably at least 130° C.);
8) heat of fusion (H_{f}) of about 40 to about 160 J/g (preferably 50 to 140 J/g, preferably 60 to 120 J/g, preferably 80 to 100 J/g);
9) crystallinity of about 5 to about 80% (preferably 10 to 75%, preferably 20 to 70%, preferably 30 to 65%, preferably 40 to 60%).
10) propylene meso diads of about 90% or more (preferably 92% or more, preferably 94% or more, preferably 96% or more);
11) heat deflection temperature (HDT) of about 45 to about 140° C. (preferably 60 to 135° C., preferably 75 to 125° C.);
12) Gardner impact strength at 23° C. of about 30 to about 1300 J (preferably 40 to 800 J, preferably 50 to 600 J); and/or
13) flexural modulus of about 300 to about 3000 MPa (preferably 600 to 2500 MPa, preferably 800 to 2000 MPa, preferably 1000 to 1500 MPa).

In a class of embodiments, the propylene-based polymer is selected from polypropylene homopolymers, polypropylene copolymers, and blends or mixtures thereof. The homopolymer may be atactic polypropylene, isotactic polypropylene, highly isotactic polypropylene, syndiotactic polypropylene, and blends or mixtures thereof. The copolymer may be a random copolymer, a statistical copolymer, a block copolymer, and blends or mixtures thereof.

The method of making the propylene-based polymers is not critical, as they may be made by slurry, solution, gas-phase, high-pressure, or other suitable processes, through the use of catalyst systems appropriate for the polymerization of polyolefins, such as Ziegler-Natta-type catalysts, metallocene-type catalysts, other appropriate catalyst systems, or combinations thereof.

In a preferred embodiment the propylene-based polymers are made by the catalysts, activators and processes described in U.S. Pat. No. 6,342,566, U.S. Pat. No. 6,384,142, WO 03/040201, WO 97/19991 and U.S. Pat. No, 5.741,563. Such catalysts are well known in the art, and are described in, for example, ZIEGLER CATALYSTS (Gerhard Fink, Rolf Mülhaupt and Hans H. Brintzinger, eds., Springer-Verlag 1995); Resconi et al., Selectivity in Propene Polymerization with Metallocene Catalysts, 100 CHEM. REV., pp. 1253-1345 (2000); and I, II METALLOCENE-BASED POLYOLEFINS (Wiley & Sons, 2000).

Suitable propylene-based polymers include Achievre™ resins, ExxonMobil™ Polypropylene resins, and Exxtral™ Performance Polyolefins available from ExxonMobil Chemical Company, Houston, Tex.

### Polymer Compositions

The films may include monolayer films made from polymer compositions comprising the first and the second polyethylene polymers described above, or multilayer films of two or more layers comprising in at least one layer polymer compositions comprising the first and the second polyethylene polymers described above. Optionally, the compositions can further comprise other additional polymers, additives, processing aids etc.

In a class of embodiments, the polymer composition may comprise from about 5 wt % to about 95 wt %, or from about 10 wt % to about 95 wt %, or from about 15 wt % to about 95 wt %, or from about 20 wt % to about 95 wt %, or from about 2.5 wt % to about 95 wt %, or from about 30 wt % to about 95 wt %, or from about 35 wt % to about 95 wt %, or from about 40 wt % to about 95 wt %, or from about 45 wt % to about 95 wt %, or from about 50 wt % to about 95 wt %, or from about 60 wt % to about 95 wt %, or from about 70 wt % to about 95 wt %, or from about 75 wt % to about 95 wt % of the first polyethylene polymer and from about 95 wt % to about 5 wt %, or from about 90 wt % to about 5 wt %, or from about 85 wt % to about 5 wt %, or from about 80 wt % to about 5 wt %, or from about 75 wt % to about 5 wt %, or from about 70 wt % to about 5 wt %, or from about 65 wt % to about 5 wt %, or from about 60 wt % to about 5 wt %, or from about 55 wt % to about 5 wt %, or from about 50 wt % to about 5 wt %, or from about 30 wt % to about 5 wt %, or from about 25 wt % to about 5 wt % of the second polyethylene polymer.

In a class of embodiments, the film may comprise two or more layers. The two or more layers may comprise at least one skin layer, a core layer, and optionally, one or more intermediary layers. Each layer may comprise a polymer composition comprising the first and second polyethylene polymers, with optional additional polymers, processing aids, and/or additives.

The at least one of the skin layer, the core layer, or optional intermediary layer may comprise from 1 wt % to 100 wt %, from 30 wt % to 100 wt %, from 40 wt % to 100 wt %, from 50 wt % to 100 wt %, from 60 wt % to 100 wt %, or from 75 wt % to 100 wt %, of the polymer composition, based upon the total weight of the respective skin layer, the core layer, or optional intermediary layer.

In a class of embodiments, the at least one of the skin layer, the core layer, or optional intermediary layer, may further comprise, for example, in a blend, at least one different polyethylene polymer and/or a polypropylene polymer. In some embodiments, the at least one different polyethylene polymer is a linear low density polyethylene polymer.

### Additives

The polymers and compositions described above may be used in combination with the following additives and other components.

### First Antioxidant

The first antioxidant comprises one or more antioxidants. They include, but are not limited to, hindered phenols, for example, octadecyl-3-(3,5-di-tertbutyl-4-hydroxyphenyl)-propionate (CAS 002082-79-3) commercially available as IRGANOX™ 1076, pentaerythritol tetrakis (3-(3,5-di-tert-butyl-4-hydroxyphenyl)propionate) (CAS 6683-19-8) commercially available as IRGANOX™ 1010; and combinations thereof.

They may be combined with one or more polymers in range from 100 to 4000 parts by weight of the first antioxidant, based on one million parts of the polymer or polymer composition; alternatively, from 250 to 3000 parts by weight of the first antioxidant, based on one million parts of the polymer or polymer composition, alternatively, from 500 to 2500 parts by weight of the first antioxidant, based on one million parts of the polymer or polymer composition, alternatively, from 750 to 2500 parts by weight of the first antioxidant, based on one million parts of the polymer or polymer composition, alternatively, from 750 to 2000 parts by weight of the first antioxidant, based on one million parts of the polymer or polymer composition, and alternatively, from 1000 to 2000 parts by weight of the first antioxidant, based on one million parts of the polymer or polymer composition.

### Second Antioxidant

The second antioxidant comprises one or more antioxidants. They include, but are not limited to, liquid phosphites, such as C₂-C₇, preferably C₂-C₄, and alkyl aryl phosphites mixed structures. Non-limiting examples include mono-amylphenyl phosphites, di-amylphenyl phosphites, dimethylpropyl phosphites, 2-methylbutanyl phosphites, and combinations thereof. In several embodiments of the invention, the second antioxidant may also be represented by the formula [4-(2-methylbutan-2-yl)pheny]ₓ[2,4-bis(2-methylbutan-2-yl)phenyl]₃₋ₓphosphate, wherein x=0, 1, 2, 3, or combinations thereof.

Such antioxidants and their use with polyolefin polymers have been described in U.S. Patent Application Nos. 2005/0113494, 2007/0021537, 2009/0326112, 2013/0190434, 2013/225738, 2014/0045981 and U.S. Pat. Nos. 5,254,709, 6,444,836, 7,888,414, 7,947,769, 8,008,383, 8,048,946, 8,188,170, and 8,258,214. An example of a commercially available liquid phosphite is sold under the trade name WESTON™ 705 (Addivant, Danbury, Conn.).

The second antioxidant may be combined with one or more polymers in the range from 100 to 4000 parts by weight of the second antioxidant, based on one million parts of the polymer or polymer composition; alternatively, from 250 to 3000 parts by weight of the second antioxidant, based on one million parts of the polymer or polymer composition, alternatively, from 300 to 2000 parts by weight of the second antioxidant, based on one million parts of the polymer or polymer composition, alternatively, from 400 to 1450 parts by weight of the second antioxidant, based on one million parts of the polymer or polymer composition, alternatively, from 425 to 1650 parts by weight of the second antioxidant, based on one million parts of the polymer or polymer composition, and alternatively, from 1 to 450 parts by weight of the second antioxidant, based on one million parts of the polymer or polymer composition.

The polymers and/or compositions comprising the first antioxidant and/or the second antioxidant described above may be used in combination with the following neutralizing agents, additional additives and other components.

### Neutralizing Agents

One or more neutralizing agents (also called catalyst deactivators) include, but are not limited to, calcium stearate, zinc stearate, calcium oxide, synthetic hydrotalcite, such as DHT4A, and combinations thereof.

### Additional Additives and Other Components

Additional additives and other components include, but are limited to, fillers (especially, silica, glass fibers, talc, etc.) colorants or dyes, pigments, color enhancers, whitening agents, cavitation agents, anti-slip agents, lubricants, plasticizers, processing aids, antistatic agents, antifogging agents, nucleating agents, stabilizers, mold release agents, and other antioxidants (for example, hindered amines and phosphates), Nucleating agents include, for example, sodium benzoate and talc. Slip agents include, for example, oleamide and erucamide.

### End Use Applications

Any of the compositions in combination with the additives and other components described herein may be used in a variety of end-use applications. Such end uses may be produced by methods known in the art. Exemplary end-use applications include but are not limited to films, film-based products, diaper components such as backsheets, housewrap, wire and cable coating compositions,. End uses also include several products made from films, e.g., bags, packaging, and personal care films, pouches, medical products, such as for example, medical films and intravenous (IV) bags.

### Films

In certain classes of embodiments, specific end use films include, for example, cast films, stretch films, stretch/cast films, stretch cling films, stretch hand wrap films, machine stretch wrap, shrink films, shrink wrap films, green house films, laminates, and laminate films. Exemplary films are prepared by any conventional technique known to those skilled in the art, such as for example, techniques utilized to prepare blown, extruded, and/or cast stretch and/or shrink films (including shrink-on-shrink applications).

In particular, the films may be used to fabricate structures for flowable materials and liquid packaging, such as pouches made from multilayer films where stiffness and toughness, flex crack resistance, and sealability and machinability become paramount properties to the end use application. Exemplary applications include but are not limited to bag-in-box packaging, non-laminated pillow packs, flexible food packaging, laminates, laminated constructions such as stand-up pouches and pillow packs, thicker films for large containers, etc. Some of these examples have been described in, for example, U.S. Pat. No. 5,972,443.

As used herein, the term “flowable material” refers to materials that are flowable under gravity or may be pumped or moved by some other mechanical means. Such materials include liquids, e.g., milk, water, soda, flavored waters, fruit juice, wine, beer, spirits, oil; emulsions, e.g., ice cream mix, soft margarine; pastes, e.g., meat pastes, peanut butter; preserves, e.g., jams, pie fillings, marmalade; jellies; doughs; ground meat e.g., sausage meat; powders e.g., gelatin powders, detergents; granular solids e.g., nuts, sugar; and like materials.

In a class of embodiments, multilayer films or multiple-layer films may be formed by methods well known in the art such as coextrusion. For example, the materials forming each layer may be coextruded through a coextrusion feedblock and die assembly to yield a film with two or more layers adhered together but differing in composition. Coextrusion can be adapted for use in both cast film or blown film processes.

Exemplary multilayer films have at least two, at least three, or at least four layers. In one embodiment the multilayer films are composed of five to ten layers. With reference to multilayer film structures of the invention comprising the same or different layers, the following notation may be used for illustration. Each layer of a film is denoted “A” or “B”. Where a film includes more than one A layer or more than one B layer, one or more prime symbols (′,″,′″ etc.) are appended to the A or B symbol to indicate layers of the same type that can be the same or can differ in one or more properties, such as chemical composition, density, melt index, thickness, etc. Finally, the symbols for adjacent layers are separated by a slash (/). Using this notation, a three-layer film having an inner layer of the polyethylene resin or blend of the invention between two outer, film layers would be denoted A/B/A′. Similarly, a five-layer film of alternating layers would be denoted A/B/A′/B′/A″. Unless otherwise indicated, the left-to-right or right-to-left order of layers does not matter, nor does the order of prime symbols; e.g., an A/B film is equivalent to a B/A film, and an A/A′/B/A″ film is equivalent to an AB/A′/A″ film.

In another class of embodiments, and using the nomenclature described above, the present invention provides multilayer films with any of the following exemplary structures: (a) two-layer films, such as A/B and B/B′; (b) three-layer films, such as A/B/A′, A/A′/B, B/A/B′ and B/B′/B″; (c) four-layer films, such as A/A′/A″/B, A/A′/B/A″, A/A′/B/B′, A/B/A′/B′, A/B/B′/A′, B/A/A′/B′, A/B/B′/B″, B/A/B′/B″ and B/B′/B″/B′″; (d) five-layer films, such as A/A′/A″/A′″/B, A/A′/A″/B/A′′, A/A′/B/A″/A′″, A/A′/A″/B/′, A/A′/B/A″/B′, A/A′/B/B′/A″, A/B/A′/B′/A″, A/B/A′/A″/B, B/A/A′/A″/B′, A/A′/B/B′/B″, A/B/A′/B′/B″, A/B/B′/B″/A′, B/A/A′/B′/B″, B/A/B′/A′/B″, B/A/B′/B″/A′, A/B/B′B″/B′″, B/A/B′/B″/B′″, B/B′/A/B″/B′″, and B/B′/B″B′″/B″″; and similar structures for films having six, seven, eight, nine, ten, eleven, twelve, thirteen, fourteen, fifteen, sixteen, seventeen, eighteen, nineteen, twenty, or more layers. It should be appreciated that films having still more layers, for example, films that comprise nanolayers, may be formed using the polymers and blends of the invention, and such films are within the scope of the invention.

The films may further be embossed, or produced or processed according to other known film processes,.

The films may be tailored to specific applications by adjusting the density, the thickness, materials and order of the various layers, as well as the additives and other components in each layer. The average density of the film can vary based upon the application desired. The average density of the film as described herein can be referred to as the average density of the polymer composition for making the film. When the polymer composition consists of the first polyethylene and the second polyethylene polymers, it can be calculated by equations: [(density of the first polyethylene polymer×percentage of the first polyethylene polymer)+(density of the second polyethylene polymer×percentage of the second polyethylene polymer)]. In some embodiments, the average density of a monolayer or multilayer film can be greater than about 0.915 g/cm³, or greater than about 0.917 g/cm³, or greater than about 0.918 g/cm³, or greater than about 0.919 g/cm³, or greater than about 0.920 g/cm³, or greater than about 0.923 g/cm³, or greater than about 0.925 g/cm³, or greater than about 0.927 g/cm³, and less than about 0.945 g/cm³, or less than about 0.940 g/cm³, or less than about 0.935 g/cm³, or less than about 0.930 g/cm³, or less than about 0.928 g/cm³, or less than about 0.926 g/cm³, or less than about 0,925 g/cm³, or any ranges between two density values described above so long as the upper limit is greater than the lower limit, e.g., from about 0.915 g/cm³ to about 0.945 g/cm³, or from about 0.917 g/cm³ to about 0.945 g/cm³, or from about 0.917 g/cm³ to about 0.935 g/cm³, or from about 0.918g/cm³ to about 0.930 g/cm³, or from about 0.918g/cm³ to about 0.928 g/cm³.

The thickness of a monolayer or a multilayer films, that comprises the polymer composition as described herein, may vary based upon the application desired. A thickness of a monolayer or a multilayer film can be greater than about 1 μm, or greater than about 5 μm, or greater than about 10 μm, or greater than about 25 μm, or greater than about 50 μm, or greater than about 100 μm. In some embodiments the total thickness of the monolayer or multilayer films can be less than about 1000 μm, or less than about 500 μm or less than about 250 μm, or less than about 200 μm, or less than about 150 μm, or less than about 120 μm, or less than about 100 μm, or less than about 80 μm, or less than 80 μm. In some embodiments the total thickness of the monolayer or multilayer films can be from about 1 to about 500 μm, from about 20 to about 200 μm, from about 50 to about 200 μm, from about 20 to about 120 μm, from about 50 to about 100 μm, from about 25 to about 100 μm, or any ranges between two thickness values described above so long as the lower limit is less than the upper limit. Those skilled in the art will appreciate that the thickness of individual layers may be adjusted based on the desired end use application and performance, resin(s) employed, equipment capability, desired output and operability constraints, and other factors.

In any of the embodiments described herein, the films may be measured for MD Elmendorf tear strength. In a class of embodiments, a monolayer or a multilayer film may have an MD Elmendorf tear strength of greater than about 6.0 g/μm, or greater than about 7.0 g/μm, or greater than 7.5 g/μm, or greater than 7.8 g/μm, or greater than 8.0 g/μm.

In any of the embodiments described herein, the film may be measured for puncture resistance. in a class of embodiments, a monolayer or a multilayer film may have a Needle Puncture force of greater than about 35 N, or greater than about 53 N, or greater than .58 N. or greater than 60 N, or greater than about 63 N.

In any of the embodiments described herein, the film may be measured for 1% modulus. In a class of embodiments, a monolayer or a multilayer film may have an MD 1% secant modulus of greater than about 150 MPa, or greater than about 160 MPa, or greater than about 170 MPa, or greater than about 180 MPa, or greater than about 190 MPa, or greater than about 200 .MPa.

In any of the embodiments described herein, the film may be measured for specular gloss at 45° (or “45° gloss”). In a class of embodiments, a monolayer or a multilayer film may have 45° gloss of greater than about 35 GU (gloss unit), or greater than about 38 GU, or greater than about 44 GU, or greater than about 50 GU, or greater than about 55 GU.

In a class of embodiments, the present film can have high stiffness, high tear strength and thin thickness, e.g., an MD 1% secant modulus of greater than about 150 MPa, or greater than 190 MPa, and an MD Elmendorf tear strength of greater than about 6.0 g/μm, or greater than about 7.0 g/μm, or greater than about 7.5 g/μm, and advantageously maintaining the film thickness of less than. about 100 μm, or less than about 80 μm, or less than about 60 μm, or less than about 55 μm, or less than about 30 μm. In the same or other certain embodiments, the density can be increased up to about 0.945 ,g/cm³, or about 0.940 g/cm³, or about 0.935 g/cm³.

In a class of embodiments, the gloss of the film described herein can be increased by increasing the thickness of the film. The film thickness can be increased till being greater than about 25 μm, or greater than about 50 μm, or greater than about 100 μm.

In a class of embodiments, the present film can have a high stiffness and/or high strength , a high gloss, and a high thickness, e.g., an MD 1% secant modulus of greater than about 150 MPa, or greater than about 190 MPa, an MD Elmendorf Tear strength of greater than 6.0 g/μm, or greater than about 7.0 g/μm, a thickness of greater than about 25 μm, or greater than about 45 μm, or greater than about 100 μm; a 45° gloss of greater than about 35 GU, or greater than about 40 GU.

### Test Methods

The properties cited below were determined in accordance with the following test procedures. Where any of these properties is referenced in the appended claims, it is to be measured in accordance with the specified test procedure.

Where applicable, the properties and descriptions below are intended to encompass measurements in both the machine and transverse directions. Such measurements are reported separately, with the designation “MD” indicating a measurement in the machine direction, and “TD” indicating a measurement in the transverse direction.

Composition Distribution Breadth Index (“CDBI”) is defined as the weight percentage of the copolymer molecules having a comonomer content within 50% of the median total molar comonomer content. The CDBI of a copolymer is readily determined utilizing well known techniques for isolating individual fractions of a sample of the copolymer. One such technique is Temperature Rising Elution Fraction (TREF), as described in Wild, et al., J. Poly. Sci., Poly. Phys. Ed., Vol. 20, p. 441 (1982) and U.S. Pat. No. 5,008,204, which are fully incorporated herein by reference.

Film thickness, reported in microns, was measured using a Measuretech Series 200 instrument. The instrument measures film thickness using a capacitance gauge. For each film sample, ten film thickness data points were measured per inch of film as the film was passed through the gauge in a transverse direction. From these measurements, an average gauge measurement was determined and reported.

Tensile properties, including Tensile at break, reported in megapascal (MPa), Elongation at break, reported in percentage (%), and 1% secant modulus (M), reported in megapascal (MPa), was measured as specified by ASTM D-882.

Elmendorf tear strength, reported in g or g/μm, was measured according to ASTM D-1922-06a.

Needle Puncture Maximum Force (Fmax) and Needle Puncture Energy at Break, reported in Newton and Needle Puncture Energy at Break reported in Joule were measured by the method ASTM D-5748. This test method covers the determination of puncture resistance of flexible packaging materials. The method proceeds with a film sample that is fastened in a sample specimen holder. A penetration probe made of hardened steel with rounded tip (0.8 mm diameter) is pushed through the film sample at a constant test speed (100 mm/min). The force is measured by a load cell and the deformation of the film sample is measured by the travel of the cross-head. The energy required to penetrate through the entire film is calculated from the force-travel curve.

Haze, reported in %, was measured by method ASTM D-1003,

Clarity, reported in %, was measured by method ASTM D-1746

Gloss (45°), or 45° gloss, reported in GU (gloss unit), can be measured according to ASTM D-2457.

### EXAMPLES

It is to be understood that while the invention has been described in conjunction with the specific embodiments thereof, the foregoing description is intended to illustrate and not limit the scope of the invention. Other aspects, advantages and modifications will be apparent to those skilled in the art to which the invention pertains.

Therefore, the following examples are put forth so as to provide those skilled in the art with a complete disclosure and description and are not intended to limit the scope of that which the inventors regard as their invention.

### Material

PE1 is a polyethylene polymer was made according to U.S. Publication No. 2015/0291748, inventive examples, referencing U.S. Pat. No. 6,956,088, and using the bis(p-propylcyclopentadienyl)HfCl_{2/}MAO catalyst system disclosed therein under polymerization conditions. PE1 had a density of 0.916 g/cm³, a melt index (I_{2.16}) of 0.5 g/10 min, a melt index ratio (I_{21.6}/I_{2.16}) of 30, a branching index of greater than 0.98. PE1 is reported to have a first peak corresponding to a log(Mw) value of about 4.5 that appears at a TREF elution temperature of 91.0° C. and a second peak at log(Mw) value of 5.3 at a TREF elution temperature of 63.0° C. PE1 can he available from ExxonMobil Chemical Company under commercial name of Exceed™ XP 8656 metallocene polyethylene resin.

PE2 is a polyethylene polymer having a density of 0.920 g/cm³, a melt index(I_{2.16}) of 0.5 g/10 min, a melt index ratio (I_{21.6}/I_{2.16}) of 42, and is available from ExxonMobil Chemical Company under commercial name of Enable™ 20-05 metallocene polyethylene resin. PE2 has an MD Elmendorf tear strength of 90 g (3.54 g/μm, ASTM D-1922), an MD 1% secant modulus of 210 MPa (ASTM D-882), a puncture force of 53 Newton, and a gloss) (45°) of 56 GU (ASTM D-2457) as measured with a film sample having a thickness of 1 mil (25.4 μm).

PE3 is a polyethylene polymer having a density of 0.927 g/cm³, a melt index(I_{2.16}) of 0.5 g/10 min, a melt index ratio (I_{21.6}/I_{2.16}) of 45, and is available from ExxonMobil Chemical Company under commercial name of Enabler™ 27-05 metallocene polyethylene resin. PE3 has an MD Elmendorf tear strength of 50 g (1.97 g/μm, ASTM D-1922), an MD 1% secant modulus of 300 MPa (ASTM D-882), a puncture force of 48 Newton, and a gloss (45°) of 49 GU (ASTM D-2457) as measured with a film sample having a thickness of 1 mil (25.4 μm).

PE4 is a polyethylene polymer having a density of 0.935 g/cm³, a melt index(I_{2.16}) of 0.5 g/10 min, a melt index ratio (I_{21.6}/I_{2.16}) of 51, and is available from ExxonMobil Chemical Company under commercial name of Enable™ 35-05 metallocene polyethylene resin. PE4 has an MD Elmendorf tear strength of 20 g (0.79 g/μm, ASTM D-1922), an MD 1% secant modulus of 430 MPa (ASTM D-882), a puncture force of 49 Newton, and a gloss (45°) of 40 GU (ASTM D-2457) as measured with a film sample having a thickness of 1 mil (25.4 μm).

PE2. to PE4 each had a branching index g′vis of less than 0.98, and films for determination of their properties are made from PE2 to PE4, respectively, on a 2.5 inch (63.5 mm) blown film line with a 2.5:1 blow-up ratio, a melt temperature of 205° C., a 0.76 mm die gap at a rate of 1.79 kg/hr/cm die circumference.

### EXAMPLES

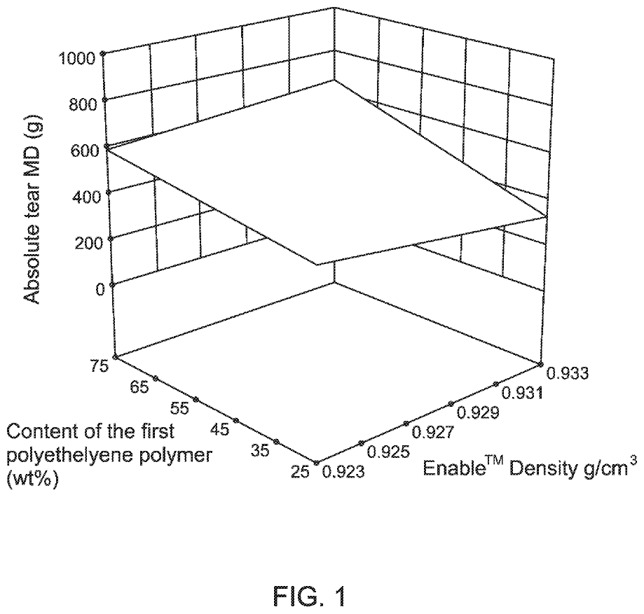

Examples of the present inventive polyethylene blown films were made by a blown film monolayer line with an extruder having 65 mm barrier screw and L/D ratio of 30 with cross hole mix. The line had screen packs of 25-80-120-25 meshes. The die had a diameter of 160 mm and a die gap of 1.5 mm. The processing conditions are shown in Table 1. The film thicknesses were adjusted by the line speed at the below given output and blow-up ratio. For each example, the polymer composition had the formulations and properties as measured shown in Tables 2, and FIG. 1 to FIG. 4. FIG. 1 to FIG. 4 are 3D models made based on the results of examples 1 to 17.

TABLE 1
Film processing conditions

| | |
|---|---|
| Blow-up ratio | 2.5 |
| Output | 110 kg/h |
| Frost line height | About 550 mm |

Temperature Setting (° C.)

| | |
|---|---|
| Zone 1 | 170 |
| Zone 2 | 180 |
| Zone 3 | 180 |
| Zone 4 | 180 |
| Zone 5 | 180 |
| Screen changer | 190 |
| Adaptor | 190 |
| Die | 200 |
| Zone 9 | 200 |
| Zone 10 | 200 |
| Zone 11 | 200 |

TABLE 2
Polymer Compositions and Tear Strength Properties

| Example | 1 | 2 | 3 | 4 | 5 | 6 | 7 | 8 | 9 |
|---|---|---|---|---|---|---|---|---|---|
| PE1 (wt %) | 75 | 75 | 75 | 50 | 25 | 25 | 90 | 50 | 50 |
| PE2 (wt %) | 25 | 25 | 25 | 50 | 75 | 75 | 0 | 0 | 0 |
| PE3 (wt %) | 0 | 0 | 0 | 0 | 0 | 0 | 10 | 50 | 50 |
| PE4 (wt %) | 0 | 0 | 0 | 0 | 0 | 0 | 0 | 0 | 0 |

Properties

| | | | | | | | | | |
|---|---|---|---|---|---|---|---|---|---|
| Film average density (g/cm³) | 0.917 | 0.917 | 0.917 | 0.918 | 0.919 | 0.919 | 0.91.7 | 0.922 | 0.922 |
| Film average thickness (μm) | 25 | 50 | 100 | 50 | 25 | 100 | 50 | 25 | 50 |

Tensile properties MD

| | | | | | | | | | |
|---|---|---|---|---|---|---|---|---|---|
| Tensile at break (MPa) | 92 | 74 | 60 | 70 | 84 | 58 | 75 | 66 | 70 |
| Elongation at break (%) | 350 | 467 | 587 | 511 | 419 | 646 | 482 | 373 | 513 |
| 1% Secant modulus (MPa) | 197 | 203 | 223 | 220 | 232 | 248 | 211 | 251 | 260 |

Tensile properties TD

| | | | | | | | | | |
|---|---|---|---|---|---|---|---|---|---|
| Tensile at break (MPa) | 56 | 61 | 59 | 62 | 59 | 56 | 36 | 48 | 57 |
| Elongation at break (%) | 645 | 649 | 651 | 664 | 683 | 699 | 531 | 620 | 678 |
| 1% Secant modulus (MPa) | 222 | 224 | 239 | 240 | 263 | 257 | 233 | 286 | 280 |

Elmendorf tear MD

| | | | | | | | | | |
|---|---|---|---|---|---|---|---|---|---|
| Absolute tear value (g) | 359 | 370 | 919 | 387 | 95 | 808 | 387 | 149 | 365 |
| Tear strength (g/μm) | 13.8 | 7.7 | 9.1 | 7.9 | 3.8 | 8.0 | 7.3 | 6.2 | 7.6 |

Elmendorf tear TD

| | | | | | | | | | |
|---|---|---|---|---|---|---|---|---|---|
| Absolute tear value (g) | 688 | 912 | 1545 | 956 | 578 | 1733 | 915 | 878 | 1176 |
| Tear strength (g/μm) | 27.5 | 19.0 | 15.3 | 19.5 | 24.1 | 17.5 | 18.3 | 35.1 | 24.0 |

Puncture resistance

| | | | | | | | | | |
|---|---|---|---|---|---|---|---|---|---|
| Fmax (N) | 37 | 62 | 102 | 61 | 36 | 100 | 63 | 35 | 60 |
| Energy at break (J) | 2 | 4 | 6 | 4 | 2 | 5 | 4 | 2 | 3 |

Optical

| | | | | | | | | | |
|---|---|---|---|---|---|---|---|---|---|
| Haze (%) | 10 | 11 | 15 | 13 | 13 | 12 | 14 | 15 | 13 |
| Clarity (%) | 75 | 70 | 66 | 72 | 70 | 68 | 69 | 69 | 71 |
| Gloss (45°, GU) | 51 | 50 | 56 | 49 | 44 | 59 | 47 | 37 | 49 |

| Example | 10 | 11 | 12 | 13 | 14 | 15 | 16 | 17 |
|---|---|---|---|---|---|---|---|---|
| PE1 (wt %) | 50 | 10 | 75 | 75 | 50 | 25 | 25 | 25 |
| PE2 (wt %) | 0 | 0 | 0 | 0 | 0 | 0 | 0 | 0 |
| PE3 (wt %) | 50 | 90 | 0 | 0 | 0 | 0 | 0 | 0 |
| PE4 (wt %) | 0 | 0 | 25 | 25 | 50 | 75 | 75 | 75 |

Properties

| | | | | | | | | |
|---|---|---|---|---|---|---|---|---|
| Film average density (g/cm³) | 0.922 | 0.926 | 0.921 | 0.921 | 0.925 | 0.930 | 0.930 | 0.930 |
| Film average thickness (μm) | 100 | 50 | 25 | 100 | 50 | 25 | 50 | 100 |

Tensile properties MD

| | | | | | | | | |
|---|---|---|---|---|---|---|---|---|
| Tensile at break (MPa) | 57 | 60 | 85 | 60 | 69 | 72 | 60 | 49 |
| Elongation at break (%) | 631 | 603 | 357 | 612 | 547 | 444 | 574 | 688 |
| 1% Secant modulus (MPa) | 275 | 316 | 259 | 271 | 337 | 412 | 395 | 412 |

Tensile properties TD

| | | | | | | | | |
|---|---|---|---|---|---|---|---|---|
| Tensile at break (MPa) | 56 | 45 | 51 | 56 | 49 | 28 | 49 | 47 |
| Elongation at break (%) | 705 | 684 | 631 | 678 | 674 | 549 | 742 | 766 |
| 1% Secant modulus (MPa) | 293 | 353 | 290 | 288 | 357 | 509 | 456 | 445 |

Elmendorf tear MD

| | | | | | | | | |
|---|---|---|---|---|---|---|---|---|
| Absolute tear value (g) | 900 | 216 | 393 | 989 | 405 | 57 | 181 | 500 |
| Tear strength (g/μm) | 9.0 | 4.5 | 15.1 | 9.7 | 8.1 | 2.1 | 3.7 | 5.1 |

Elmendorf tear TD

| | | | | | | | | |
|---|---|---|---|---|---|---|---|---|
| Absolute tear value (g) | 1910 | 1088 | 950 | 1928 | 1455 | 1300 | 1286 | 2107 |
| Tear strength (g/μm) | 19.1 | 22.2 | 38.0 | 18.9 | 29.7 | 50.0 | 26.8 | 21.5 |

Puncture resistance

| | | | | | | | | |
|---|---|---|---|---|---|---|---|---|
| Fmax (N) | 104 | 61 | 35 | 108 | 63 | 38 | 63 | 115 |
| Energy at break (J) | 6 | 3 | 2 | 6 | 3 | 2 | 3 | 6 |

Optical

| | | | | | | | | |
|---|---|---|---|---|---|---|---|---|
| Haze (%) | 14 | 14 | 14 | 17 | 17 | 23 | 17 | 17 |
| Clarity (%) | 67 | 68 | 68 | 62 | 64 | 55 | 62 | 61 |
| Gloss (45°, GU) | 53 | 47 | 38 | 51 | 38 | 24 | 34 | 45 |

Table 2 shows that the present films have good balance in mechanical properties, e.g. an MD 1% secant modulus of greater than about 190 MPa, indicating good stiffness performance, an MD Elmendorf tear strength of greater than about 2 g/μm, and puncture resistance of greater than about 35 N, indicating a good toughness performance, as shown in examples 1 to 17.

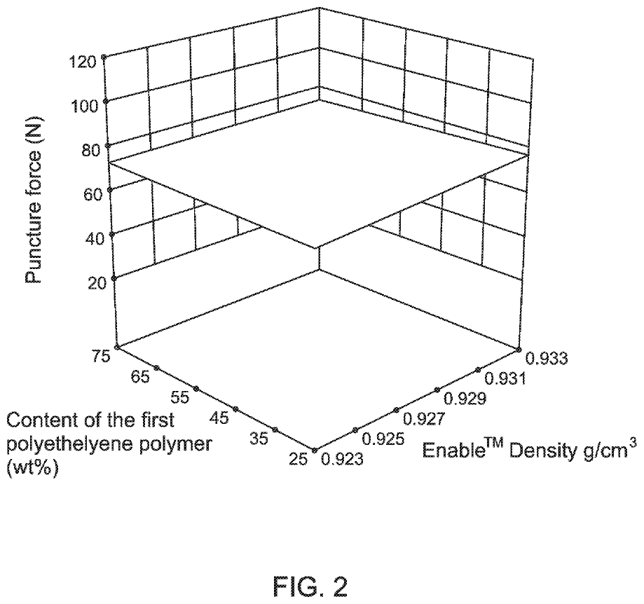

It can also been seen from Table 2 that when the film average density increases, the present films have increased 1% secant modulus, while other mechanical properties of the films, such as Elmendorf tear strength and puncture resistance, can be kept substantially stable, for example, by comparing examples 1 and 12, examples 3 and 13, examples 4, 9 and 14, examples 5 and 15, and examples 6 and 17, in which each group of exemplified films have the same polyethylene polymer splits and the same thickness but different densities, whereas the films consisted of only PE2, PE3 and PE4 show a clear decreasing trend on Elmendorf tear strength and puncture resistance along the increase in the film densities, as shown by the aforementioned properties of PE2, PE3, and PE4. This demonstrates that by increasing the density of the present films, a balance of increased stiffness and maintained toughness can be obtained. The 3D models shown in FIG. 1 and FIG. 2 also indicate the increased stiffness along increase in film density with substantially consistent physical performance such as tear strength of the present films, despite of the variation of the densities of the films.

It can been seen from Table 2 that when the addition amount of the first polyethylene polymer is greater than about 25 wt %, the toughness properties of the present inventive films, e.g., MD Elmendorf tear strength can be greater than 6.0 g/μm, despite of the thickness of the films, also shown by FIG. 1.

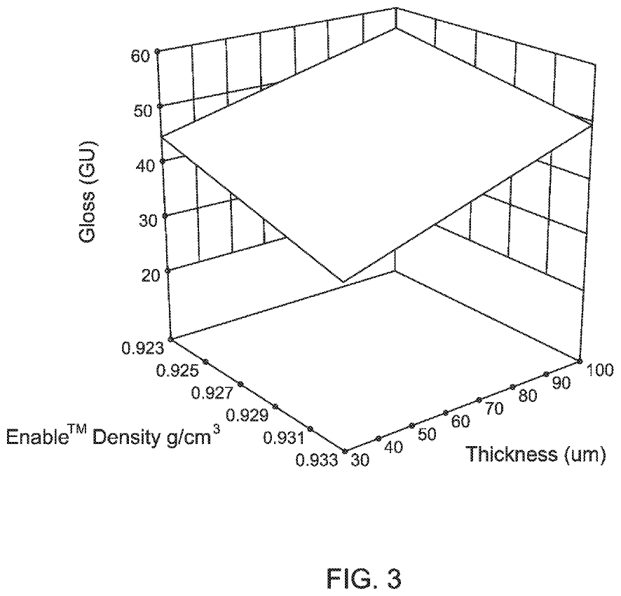

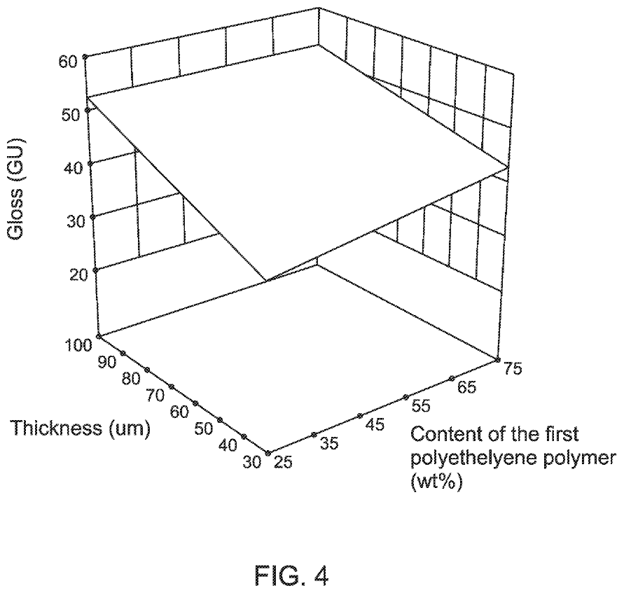

Table 2 also shows that the present inventive films have good optical performance, in particular, when the film thickness increased from 25 to 100 μm, for example, by comparing examples 1 and 2 and 3, examples 5 and 6, examples 8 and 9, examples 12 and 13, and examples 15 and 16 and 17, each pairs of the exemplified films have the same formulations but different thicknesses, the 45° gloss increases. This provides a simple way to increase the 45° gloss optical performance of a film, i.e., by simply increasing the film thickness. FIG. 3 and FIG. 4 shows that the increase of film thickness improves the gloss of the films, and FIG. 4 further shows the addition content of the first polyethylene polymer to the films does not significantly impact the trend of increase in 45° gloss.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present invention. Further, all documents and references cited herein, including testing procedures, publications, patents, journal articles, etc., are herein fully incorporated by reference for all jurisdictions in which such incorporation is permitted and to the extent such disclosure is consistent with the description of the present invention.

While the invention has been described with respect to a number of embodiments and examples, those skilled in the art, having benefit of this disclosure, will appreciate that other embodiments can be devised which do not depart from the scope and spirit of the invention as disclosed herein.

What is claimed is:

1. A film comprising a polymer composition comprising from 5 wt % to 95 wt % of a first polyethylene polymer and from 95 wt % to 5 wt % of a second polyethylene polymer, wherein
(1) the first polyethylene polymer comprises from 70 wt % to 100 wt % ethylene derived units and having a density of from 0.910 g/cm³ to 0.940 g/cm³ and a branching index g′ᵥᵢₛ of 0.98 or more, a melt index ratio (I_{21.6}/I_{2.16}) of from 25 to 32, and
(2) the second polyethylene polymer comprises from 80 wt % to 99 wt % of ethylene derived units and having a density of from 0.905 g/cm³ to 0.945 g/cm³, a branching index g′ᵥᵢₛ of less than 0.98, and a melt index ratio (I_{21.6}/I_{2.16}) of from 25 to 80.

2. The film of claim 1, wherein the polymer composition comprises from 25 wt % to 95 wt % of the first polyethylene polymer and from 75 wt % to 5 wt % of the second polyethylene polymer.

3. The film of claim 1, wherein the polymer composition comprises from 45 wt % to 95 wt % of the first polyethylene polymer and from 55 wt % to 5 wt % of the second polyethylene polymer,

4. The film of claim 1, wherein the first polyethylene polymer has a density of from 0.912 g/cm³ to 0.925 g/cm³.

5. The film of claim 1, wherein the first polyethylene polymer has a melt index ratio (I_{21.6}/I_{2.16}) of from 25 to 32.

6. The film of claim 1, wherein the first polyethylene polymer has a branching index of greater than 0.99.

7. The film of claim 1, wherein the first polyethylene polymer has at least one of the following properties:
a melt index (I_{2.16}) of from 0.1 g/10 min to 5.0 g/10 min;
a molecular weight of from 15,000 to 400,000 g/mol;
a molecular weight distribution (Mw/Mn) of from 1.5 to 5.0;
a CDBI of less than 50%;
a hafnium concentration of greater than 5 ppm by weight; or
a hafnium to zirconium ratio (ppm/ppm) ≥1.0.

8. The film of claim 1, wherein the first polyethylene polymer has at least one of the following properties:
a melt index (I_{2.16}) of from 0.2 g/10 min to 1.5 g/10 min;
a molecular weight of from 20,000 to 200,000 g/mol;
a molecular weight distribution (Mw/Mn) of from 2.0 to 4.0;
a CDBI of less than 45%;
a hafnium concentration of greater than 5 ppm by weight; or
a hafnium to zirconium ratio (ppm/ppm) ≥2.0.

9. The film of claim 1, wherein the first polyethylene polymer has at least a first peak and a second peak in a comonomer distribution analysis and wherein the first peak has a maximum at a log (Mw) value of from 4.0 to 5.4 and a TREF elution temperature of from 70.0° C. to 100.0° C. and the second peak has a maximum at a log (Mw) value of from 5.0 to 6.0 and a TREF elution temperature of from 40.0° C. to 70.0° C.

10. The film of claim 1, wherein the first polyethylene polymer has at least a first peak and a second peak in a comonomer distribution analysis and wherein the first peak has a maximum at a log (Mw) value of from 4.3 to 50 and a TREF elution temperature of from 80.0° C. to 95.0° C. and the second peak has a maximum at a log (Mw) value of from 5.0 to 5.7 and a TREF elution temperature of from 45.0° C. to 65.0° C.

11. The film of claim 1, wherein the second polyethylene polymer has a density of from 0.915 g/cm³ to 0.945 g/cm³.

12. The film of claim 1, wherein the second polyethylene polymer has a melt index ratio (I_{21.6}/I_{2.16}) of from 35 to 70.

13. The film of claim 1, wherein the second polyethylene polymer has a branching index of from 0.65 to 0.98.

14. The film of claim 1, wherein the second polyethylene polymer has at least one of the following properties:
a melt index (I_{2.16}) of from 0.1 g/10 min to 3.0 g/10 min;
a CDBI of greater than 50%, and
a molecular weight distribution (Mw/Mn) of from 2.5 to 5.5.

15. The film of claim 1, wherein the second polyethylene polymer has at least one of the following properties:
a melt index (I_{2.16}) of from 0.2 g/10 min to 2.0 g/10 min;
a CDBI of greater than 70%; and
a molecular weight distribution (Mw/Mn) of from 3.0 to 4.0.

16. The film of claim 1, wherein the film has an average density of from 0.915 g/cm³ to 0.945 g/cm³.

17. The film of claim 1, wherein the film has an MD Elmendorf tear strength, as determined according to ASTM D-1922, of greater than 6.0 g/μm.

18. The film of claim 1, wherein the film has an MD 1% secant modulus, as determined according to ASTM D-882, of greater than 150 MPa.

19. The film of claim 1, wherein the film has a thickness of less than about 100 μm, an MD Elmendorf tear strength, as determined according to ASTM D-1922, of greater than 6.0 g/μm, and an MD 1% secant modulus, as determined according to ASTM D-882, of greater than 150 MPa

20. The film of claim 1, wherein the film has a thickness of greater than about 25 μm, a 45° gloss, as determined according to ASTM D-2457, of greater than 35 GU, an MD Elmendorf tear strength, as determined according to ASTM D-1922, of greater than 6.0 g/μm, and an MD 1% secant modulus, as determined according to ASTM D-882, of greater than 150 MPa.

21. The film comprising a polymer composition comprising from 25 wt % to 95 wt % of a first polyethylene polymer and from 75 wt % to 5 wt % of a second polyethylene polymer, wherein
(1) the first polyethylene polymer comprises from 70 wt % to 100 wt % ethylene derived units and having a density of from 0.910 g/cm³ to 0.940 g/cm³ and a branching index g′ᵥᵢₛ of 0.98 or more, a melt index ratio (I_{21.6}/I_{2.16}) of from 25 to 32, and
(2) the second polyethylene polymer comprises from 80 wt % to 99 wt % of ethylene derived units and having a density of from 0.915 g/cm³ to 0.945 g/cm³, a branching index g′ᵥᵢₛ of less than 0.98, and a melt index ratio (I_{21.6}/I_{21.6}) of from 25 to 80,
wherein the film has an average density of greater than about 0.915 g/cm³, an MD 1% secant modulus, as determined according to ASTM D-882, of greater than 150 MPa, and an MD Elmendorf tear strength, as determined according to ASTM D-1922, of greater than about 6.0 g/μm.

22. An article comprising the film of claim 21.

23. A method of improving 45° gloss of a film comprising a polymer composition comprising a first polyethylene polymer and a second polyethylene polymer,
wherein the first polyethylene polymer comprising from 70 wt % to 100 wt % ethylene derived units and having a density of from 0.910 g/cm³ to less than 0.940 g/cm³ and a branching index g′ᵥᵢₛ of 0.98 or more, a melt index ratio (I_{21.6}/I_{2.16}) of from 25 to 32, and the second polyethylene polymer comprising from 80 wt % to 99 wt % of ethylene derived units and having a density of from 0.905 g/cm³ to 0.945 g/cm³, a branching index g′ᵥᵢₛ of less than 0.98, and a melt index ratio (I_{21.6}/I_{2.16}) of from 25 to 80,
wherein the method comprises the step of increasing the film thickness to about 25 μm or more.

24. The use of a composition comprising a first polyethylene polymer and a second polyethylene polymer, wherein the first polyethylene polymer comprising from 70 wt % to 100 wt % ethylene derived units and having a density of from 0.910 g/cm³ to less than 0.940 g/cm³ and a branching index g′ᵥᵢₛ of 0.98 or more, a melt index ratio (I_{21.6}/I_{2.16}) of from 25 to 32, and the second polyethylene polymer comprising from 80 wt % to 99 wt % of ethylene derived units and having a density of from 0.905 g/cm³ to 0.945 g/cm³, a branching index g′ᵥᵢₛ of less than 0.98, and a melt index ratio (I_{21.6}/I_{2.16}) of from 25 to 80 in a film having a thickness of about 25 μm or more to improve the 45° gloss of the film.

25. The use of claim 24, wherein the 45° gloss of the film, as determined according to ASTM D-2457, is greater than 35 GU.
